(19) United States
(12) Patent Application Publication
(10) Pub. No.: US 2019/0268466 A1
(43) Pub. Date: Aug. 29, 2019

(54) NUMBER PORTABILITY INFORMATION MANAGEMENT SYSTEM

(71) Applicant: NEC CORPORATION, Tokyo (JP)

(72) Inventor: Tetsuo INOUE, Tokyo (JP)

(73) Assignee: NEC CORPORATION, Tokyo (JP)

(21) Appl. No.: 16/320,364

(22) PCT Filed: Jun. 28, 2017
(86) PCT No.: PCT/JP2017/023795

§ 371 Date: Jan. 24, 2019

(30) Foreign Application Priority Data
Jul. 28, 2016 (JP) 2016-148245

(51) Int. Cl. H04M 3/42; H04L 9/06; H04L 9/32; H04L 9/30; G06F 16/23; G06F 16/245; H04L 29/08

(52) U.S. Cl. CPC H04M 3/42297; H04L 9/0637; H04L 9/3247; H04L 9/3073; H04L 9/3263; H04W 8/28; G06F 16/245; H04L 67/1078; H04L 2209/38; H04M 2203/558; G06F 16/2379

(57) ABSTRACT

A node device configuring a peer-to-peer network includes a network interface and a blockchain management part. The blockchain management part receives, via the network interface, an information registration request transaction that includes information including a telephone number of a user terminal and subscribing carrier information, an electronic signature made on the information with a private key of the user terminal, and a public key paired with the private key. The blockchain management part accumulates the received information registration request transaction into a blockchain based on a consensus building algorithm executed in cooperation with another node device configuring the peer-to-peer network.

### TECHNICAL FIELD

The present invention relates to a number portability information management system, a number portability information management method, a node device, a program, and an information registrant device.

### BACKGROUND ART

Number portability is a mechanism which enables continuous use of a telephone number without change even if a subscriber relocates or a telecommunications service provider and a communication service change. Number portability is also called a number portability system.

In order to realize number portability, it is necessary to associate a telephone number with a new location. There are various methods for managing a database which associates a telephone number with a new location (hereinafter referred to as a number portability DB), one of which is a common DB method.

In the common DB method, a common database is operated with a fund contributed by service providers and accepts all routing inquiries. The common DB method is a method adopted in the North American Numbering Plan (see Non-Patent Document 1, for example).
Non-Patent Document 1: “Number Portability—Wikipedia,” [searched on Jun. 17, 2016], [online]<URL: https://ja.wikipedia.org/wiki/% E7%95%AA%E5%8F%B7%E3%83%9D%E3%83%BC%E3% 82%BF%E3%83%93%E3%83%AA%E3%83%86%E3%82%A3>
Non-Patent document 2: Satoshi Nakamoto, “Bitcoin A Peer-to-Peer Electronic Cash System,” [online], [searched on Jun. 17, 2016], Internet <URL: https://bitcoin.org/bitcoin.pdf>
Non-Patent document 3: Chin Cheng Liang, “A Next-Generation Smart Contract and Decentralized Application Platform,” [online], [searched on Jun. 17, 2016], Internet <URL: https://github.com/ethereum/wiki/wiki/White-Paper>

However, in the common DB system, a single number portability DB is managed with a fund contributed by all the service providers. For this reason, there is a problem that the single number portability DB becomes a bottleneck and capabilities such as reliability, availability and maintainability decrease.

### SUMMARY

An object of the present invention is to provide a number portability information management system which solves the above-described problem.

A number portability information management system as an aspect of the present invention includes a peer-to-peer network configured by a plurality of node devices capable of peer-to-peer communication with each other and an information registrant device. The information registrant device includes a first network interface and an information registration request transaction generating part configured to generate an information registration request transaction and broadcast the information registration request transaction to the peer-to-peer network via the first network interface. The information registration request transaction generating part is configured to generate the information registration request transaction based on information including a telephone number of a user terminal and subscribing carrier information, an electronic signature made on the information with a private key of the user terminal, and a public key paired with the private key. Each of the node devices includes a second network interface and a blockchain management part configured to accumulate the received information registration request transaction into a blockchain via the second network interface based on a consensus building algorithm executed in cooperation with another node device.

A node device as another aspect of the present invention is a node device configuring a peer-to-peer network. The node device includes a network interface and a blockchain management part. The blockchain management part is configured to: receive, via the network interface, an information registration request transaction including information including a telephone number of a user terminal and subscribing carrier information, an electronic signature made on the information with a private key of the user terminal, and a public key paired with the private key; and accumulate the received information registration request transaction into a blockchain based on a consensus building algorithm executed in cooperation with another node device configuring the peer-to-peer network.

A number portability information management method as another aspect of the present invention is a number portability information management method executed by a node device including a network interface and a blockchain management part and configuring a peer-to-peer network. The number portability information management method includes: by the blockchain management part, receiving, via the network interface, an information registration request transaction including information including a telephone number of a user terminal and subscribing carrier information, an electronic signature made on the information with a private key of the user terminal, and a public key paired with the private key; and by the blockchain management part, accumulating the received information registration request transaction into a blockchain based on a consensus building algorithm executed in cooperation with another node device configuring the peer-to-peer network.

A computer program as another aspect of the present invention includes instructions for causing a computer configuring a peer-to-peer network to function as: a network interface; and a blockchain management part. The blockchain management part is configured to: receive, via the network interface, an information registration request transaction including information including a telephone number of a user terminal and subscribing carrier information, an electronic signature made on the information with a private key of the user terminal, and a public key paired with the private key; and accumulate the received information registration request transaction into a blockchain based on a consensus building algorithm executed in cooperation with another node device configuring the peer-to-peer network.

An information registrant device as another aspect of the present invention is an information registrant device broadcasting an information registration request transaction to a peer-to-peer network configured by a plurality of node devices capable of peer-to-peer network with each other. The information registrant device includes: a network interface; and an information registration request transaction generating part configured to generate the information registration request transaction and broadcast the information registration request transaction to the peer-to-peer network via the network interface. The information registration request transaction generating part is configured to generate the information registration request transaction based on information including a telephone number of a user terminal and subscribing carrier information, an electronic signature made on the information with a private key of the user terminal, and a public key paired with the private key.

With the configurations as described above, the present invention can provide a number portability information management system which has excellent reliability, availability and maintainability.

### BRIEF DESCRIPTION OF DRAWINGS

FIG. 1 is a configuration diagram of a second example embodiment of the present invention;

FIG. 2 is a configuration diagram of a third example embodiment of the present invention;

FIG. 3 is an information component diagram showing a relation of contents of between information retained in a telephone number subscriber device and a transaction to request registration of information in a number portability DB;

FIG. 4 is an information component diagram showing a relation of contents between a plurality of transactions and a plurality of blocks in a blockchain;

FIG. 5 is a signal sequence diagram showing how an information registration request transaction is broadcast from a telephone number subscriber device to a peer-to-peer network that manages a number portability DB;

FIG. 6 is a flow diagram showing how an information registration request transaction signal is transmitted to a peer-to-peer network that manages a number portability DB in a telephone number subscriber device;

FIG. 7 is a signal sequence diagram for incoming call analysis in a communications carrier device (for example, a telephone exchange);

FIG. 8 is a flow diagram showing how, in an incoming call analysis process, another communications carrier device broadcasts a query request transaction to a peer-to-peer network that manages a number portability DB and confirms subscribing communications carrier information for the incoming call telephone number;

FIG. 9 is a diagram showing an example of judgment whether or not public keys of a plurality of information registration request transactions relating to an identical telephone number match in a fourth example embodiment of the present invention;

FIG. 10 is an explanatory diagram of steps for generating an information registration request transaction when updating to a new key pair;

FIG. 11 is a diagram showing an example of a plurality of information registration request transactions relating to an identical telephone number accumulated in a blockchain;

FIG. 12 is a flow diagram showing how an information registration request transaction signal is transmitted to a peer-to-peer network that manages a number portability DB in a telephone number subscriber device in the fifth example embodiment of the present invention;

FIG. 13 is a flowchart showing an example of processing by a node participating in the peer-to-peer network in the fourth and fifth example embodiments of the present invention;

FIG. 14 is a diagram showing a configuration example of a sixth example embodiment of the present invention;

FIG. 15 is an explanatory diagram of steps for generating an information registration request transaction (for a new public key) in the sixth example embodiment of the present invention;

FIG. 16 is a signal sequence diagram showing how an information registration request transaction is broadcast from a number management bureau device to a peer-to-peer network that manages a number portability DB in the sixth example embodiment of the present invention;

FIG. 17 is a flow diagram showing how an information registration request transaction signal is transmitted to the peer-to-peer network that manages the number portability DB in the number management bureau device in the sixth example embodiment of the present invention;

FIG. 18 is a diagram showing another configuration example of the sixth example embodiment of the present invention;

FIG. 19 is an explanatory diagram of steps for generating an information registration request transaction (for a new public key) in the sixth example embodiment of the present invention;

FIG. 20 is a signal sequence diagram showing how an information registration request transaction is broadcast from an initial communications carrier device to the peer-to-peer network that manages the number portability DB in the sixth example embodiment of the present invention;

FIG. 21 is a flow diagram showing how an information registration request transaction signal is transmitted to the peer-to-peer network that manages the number portability DB in the initial communications carrier device in the sixth example embodiment of the present invention;

FIG. 22 is a diagram showing still another configuration example of the sixth example embodiment of the present invention;

FIG. 23 is an explanatory diagram of steps for generating an information registration request transaction (for a new public key) in the sixth example embodiment of the present invention;

FIG. 24 is a signal sequence diagram showing how an information registration request transaction is broadcast from a subscriber device to the peer-to-peer network that manages the number portability DB in the sixth example embodiment of the present invention;

FIG. 25 is a flow diagram showing how an information registration request transaction signal is transmitted to the peer-to-peer network that manages the number portability DB in the subscriber device in the sixth example embodiment of the present invention;

FIG. 26 is a flowchart showing an example of processing by a node participating in the peer-to-peer network in the sixth example embodiment of the present invention;

FIG. 27 is a flowchart showing an example of processing by the node participating in the peer-to-peer network in the sixth example embodiment of the present invention;

FIG. 28 is a flowchart showing an example of processing by the node participating in the peer-to-peer network in the sixth example embodiment of the present invention;

FIG. 29 is a flowchart showing an example of processing by the node participating in the peer-to-peer network in the sixth example embodiment of the present invention;

FIG. 30 is a flowchart showing an example of processing by the node participating in the peer-to-peer network in the sixth example embodiment of the present invention;

FIG. 31 is a diagram for describing a task to be solved by a seventh example embodiment of the present invention;

FIG. 32 is a diagram showing a configuration example of the seventh example embodiment of the present invention;

FIG. 33 is an explanatory diagram of a subscription ID included in a subscription certificate in the seventh example embodiment of the present invention;

FIG. 34 is an explanatory diagram of steps for generating an information registration request transaction in the seventh example embodiment of the present invention;

FIG. 35 is a signal sequence diagram showing how an information registration request transaction is broadcast from a subscriber device to a peer-to-peer network that manages a number portability DB in the seventh example embodiment of the present invention;

FIG. 36 is a flow diagram showing how an information registration request transaction signal is transmitted to the peer-to-peer network that manages the number portability DB in the subscriber device in the seventh example embodiment of the present invention;

FIG. 37 is a flowchart showing an example of processing by a node participating in the peer-to-peer network in the seventh example embodiment of the present invention;

FIG. 38 is a diagram showing a configuration example of a first example embodiment of the present invention;

FIG. 39 is a flowchart showing an example of a procedure to register number portability information in the first example embodiment of the present invention;

FIG. 40 is a flowchart showing an example of a procedure to use (a procedure to refer to) number portability information in the first example embodiment of the present invention; and

FIG. 41 is a diagram showing a configuration example of an eighth example embodiment of the present invention.

### EXAMPLE EMBODIMENTS

Next, example embodiments of the present invention will be described in detail with reference to the drawings.

### First Example Embodiment

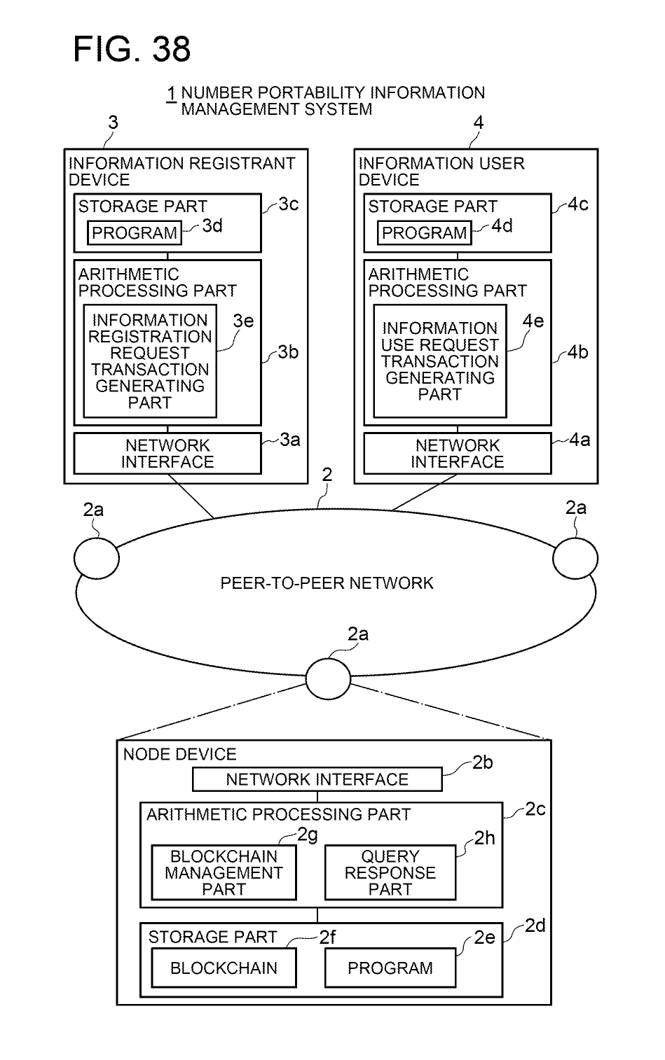

With reference to FIG. 38, a number portability information management system 1 according to a first example embodiment of the present invention includes a peer-to-peer network 2, an information registrant device 3, and an information user device 4.

The information registrant device 3 is a device used by a person who registers number portability information, and one or more devices are provided. The information registrant device 3 includes a network interface 3a, an arithmetic processing part 3b, and a storage part 3c.

The network interface 3a is composed of a dedicated data communication circuit, and has a function to perform data communication with the peer-to-peer network and the like connected via a wired or wireless communication line.

The storage part 3c is composed of a storage device such as a hard disk and a memory, and has a function to store processing information and a program 3d that are necessary for various processing by the arithmetic processing part 3b. The program 3d is a program loaded and executed by the arithmetic processing part 3b to realize various processing parts. The program 3d is previously loaded from an external device (not shown) or a program storage medium (not shown) via a data input/output function such as the network interface 3a and stored into the storage part 3c.

The arithmetic processing part 3b has a microprocessor such as a CPU and a peripheral circuit thereof, and has a function to load and execute the program 3d from the storage part 3c and make the above-described hardware and the program 3d cooperate to realize various processing parts. A major processing part realized by the arithmetic processing part 3b is an information registration request transaction generating part 3e.

The information registration request transaction generating part 3e has a function to generate an information registration request transaction and broadcast the transaction to the peer-to-peer network 2 via the network interface 3a. Based on information including a telephone number and subscribing carrier information of a user terminal, an electronic signature obtained by signing the information with a private key of the user terminal, and a public key paired with the private key, the information registration request transaction generating part 3e generates the information registration request transaction. The information including the telephone number and subscribing carrier information of the user terminal is also referred to as number portability information.

The information user device 4 is a device used by a person who uses the number portability information, and one or more devices are provided. The information user device 4 includes a network interface 4a, an arithmetic processing part 4b, and a storage part 4c.

The network interface 4a is composed of a dedicated data communication circuit, and has a function to perform data communication with the peer-to-peer network 2 and the like connected via a wired or wireless communication line.

The storage part 4c is composed of a storage device such as a hard disk and a memory, and has a function to store processing information and a program 4d that are necessary for various processing by the arithmetic processing part 4b. The program 4d is a program loaded and executed by the arithmetic processing part 4b to realize various processing parts. The program 4d is previously loaded from an external device (not shown) or a program storage medium (not shown) via a data input/output function such as the network interface 4a and stored into the storage part 4c.

The arithmetic processing part 4b has a microprocessor such as a CPU and a peripheral circuit thereof, and has a function to load the program 4d from the storage part 4c and execute the program to make the above-described hardware and the program 4d cooperate and realize various processing parts. A major processing part realized by the arithmetic processing part 4b is an information use request transaction generating part 4e.

The information use request transaction generating part 4e has a function to generate an information use request transaction to put a query about subscribing carrier information corresponding to a telephone number and broadcast the transaction to the peer-to-peer network 2 via the network interface 4a. The information use request transaction generating part 4e also has a function to receive a response to the query by the information use request transaction via the network interface 4a.

The peer-to-peer network 2 is composed of a plurality of node devices 2a capable of peer-to-peer communication with each other. Each of the node devices 2a includes a network interface 2b, an arithmetic processing part 2c, and a storage part 2d.

The network interface 2a is composed of a dedicated data communication circuit, and has a function to perform data communication with various devices such as the other node device 2a, the information registrant device 3 and the information user device 4 connected via a wired or wireless communication line.

The storage part 2d is composed of a storage device such as a hard disk and a memory, and has a function to store processing information and a program 2e that are necessary for various processing by the arithmetic processing part 2c. The program 2e is a program loaded and executed by the arithmetic processing part 2c to realize various processing parts. The program 2e is previously loaded from an external device (not shown) or a program storage medium (not shown) via a data input/output function such as the network interface 2b and stored into the storage part 2d. Major processing information stored in the storage part 2d is a blockchain 2f.

The blockchain 2f is a data structure in which blocks each grouping transactions over a certain period are connected in a chain. For example, the blockchain 2f may be a blockchain of Ethereum, but is not limited to it. The blockchain 2f is also referred to as a number portability DB.

The arithmetic processing part 2c has a microprocessor such as a CPU and a peripheral circuit thereof, and has a function to load the program 2e from the storage part 2d and execute the program to make the above-described hardware and the program 2e cooperate and realize various processing parts. Major processing parts realized by the arithmetic processing part 2c are a blockchain management part 2g and a query response part 2h.

The blockchain management part 2g has a function to accumulate information registration request transactions received via the network interface 2b into the blockchain 2f, based on a consensus building algorithm executed in cooperation with the other node 2a. A consensus building algorithm refers to a general algorithm for mutually approving a distributed ledger by using Proof of Work (PoW) or the like. PoW is equivalent to an operation called “mining” in Bitcoin and Ethereum.

The query response part 2h has a function to, upon receiving an information query request via the network interface 2b, acquire subscribing carrier information associated with a telephone number contained in the information query request, from the information accumulated in the blockchain 2f, and generate a response for transmitting via the network interface 2b.

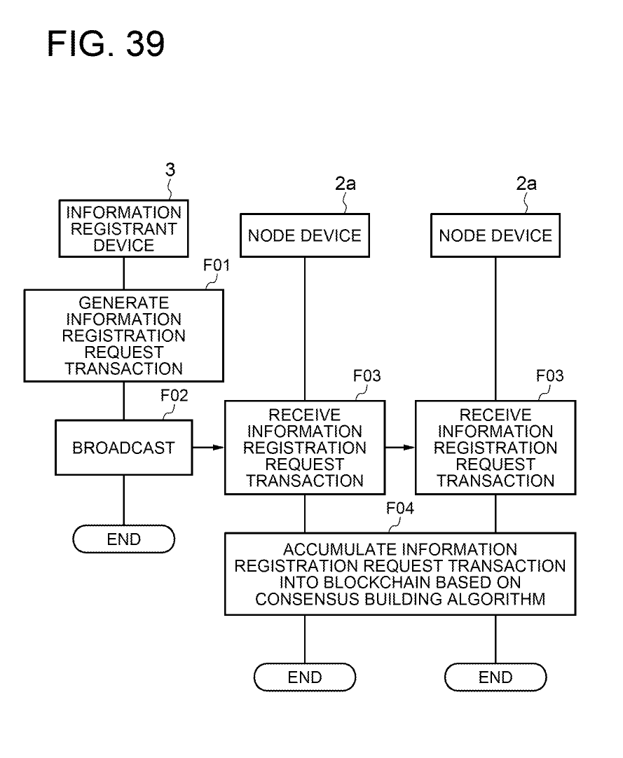

FIG. 39 is a flowchart showing an example of a number portability information registration procedure. With reference to FIG. 39, the information registrant device 3 causes the information registration request transaction generating part 3e to generate an information registration request transaction (F01). An information registration request transaction includes number portability information including a telephone number and subscribing carrier information of a user terminal, an electronic signature obtained by signing the information with a private key of the user terminal, and a public key paired with the private key. Next, the information registration device 3 broadcasts the information registration request transaction to the peer-to-peer network 2 via the network interface 3a (F02).

Each of the node devices 2a causes the network interface 2b to receive the information registration request transaction having been broadcast to the peer-to-peer network 2 (F03). Next, each of the node devices 2a causes the blockchain management part 2g to accumulate the received information registration request transaction into the blockchain 2f, based on a consensus building algorithm executed in cooperation with the other node device 2a (F04).

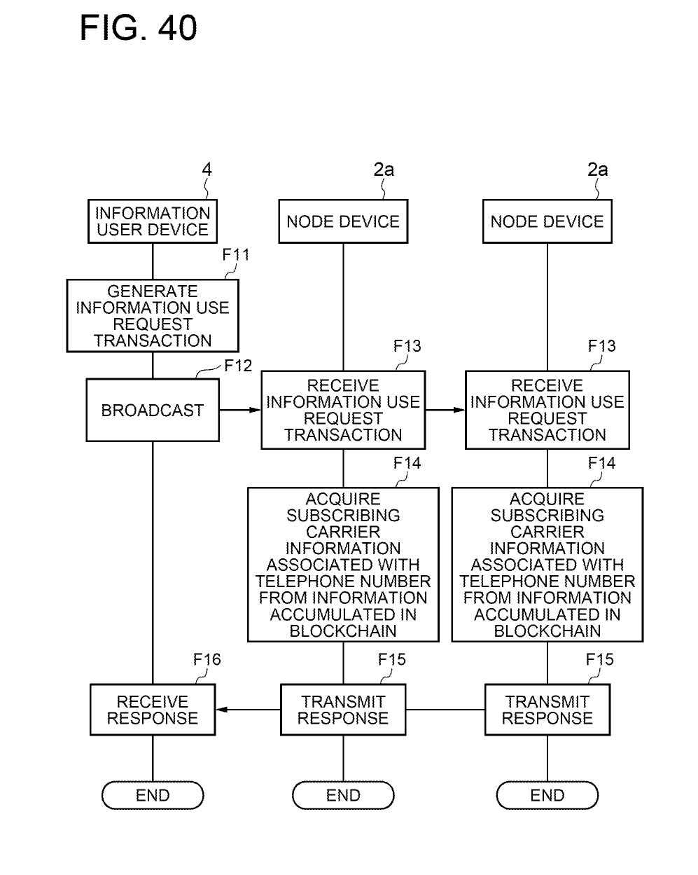

FIG. 40 is flowchart showing an example of a number portability information use procedure (reference procedure). With reference to FIG. 40, the information user device 4 causes the information use request transaction generating part 4e to generate an information use request transaction to query about subscribing carrier information associated with a telephone number (F11). Next, the information user device 4 causes the network interface 4a to broadcast the information use request transaction to the peer-to-peer network 2 (F12).

Each of the node devices 2a causes the network interface 2b to receive the information use request transaction having been broadcast to the peer-to-peer network 2 (F13). Next, each of the node devices 2a causes the query response part 2h to acquire subscribing carrier information associated with a telephone number included in an information query request from the information accumulated in the blockchain 2f (F14). Next, each of the node devices 2a causes the network interface 2b to transmit a response including the information having been acquired to the information user device 4 (F15).

The information user device 4 causes the network interface 4a to receive the response from the node device 2a (F16).

Thus, according to this example embodiment, the number portability information is managed by using the blockchain technology, so that it is possible to provide a number portability information management system that has excellent reliability, availability, and maintainability.

In this example embodiment, various additions and modifications can be made based on the above configuration and operation.

For example, the blockchain management part 2g may be configured to retrieve another information registration request transaction including the same telephone number as a telephone number included in an information registration request transaction having been received, from the blockchain 2f, and judge the validity of the information registration request transaction having been received, based on the result of comparison between a public key included in the other information registration request transaction having been retrieved and a public key included in the information registration request transaction having been received.

Further, the blockchain management part 2g may be configured to, when the public key included in the information registration request transaction having been received matches public keys included in all the other information registration request transactions having been retrieved, judge the information registration request transaction having been received is valid.

Further, the blockchain management part 2g may be configured to, when the public key included in the information registration request transaction having been received matches the latest public key included in the other information registration request transaction having been retrieved, judge the information registration request transaction having been received is valid.

Further, the information registration request transaction generating part 3e may be configured to generate an information registration request transaction, based on information including a telephone number of a user terminal and a new public key to be used instead of a public key of the user terminal, an electronic signature obtained by signing the information with a private key of the user terminal, and a public key paired with the public key.

Further, the information registration request transaction generating part 3e may be configured to generate an information registration request transaction, based on information including a telephone number of a user terminal and new subscribing carrier information to be used instead of subscribing carrier information, an electronic signature obtained by signing the information with a private key of the user terminal, and a public key paired with the public key.

Further, the information registration request transaction generating part 3e may be configured to generate an information registration request transaction, based on information including a telephone number and a new public key and also including an outsourcing certificate or a subcontract certificate, an electronic signature obtained by signing the information with a predetermined private key, and a public key paired with the predetermined public key.

Further, the blockchain management part 2g may be configured to judge the validity of the received information registration request transaction, based on the outsourcing certificate or the subcontract certificate included in the received information registration request transaction.

Further, the information registration request transaction generating part 3e may be configured to include a subscription ID obtained by encrypting secret information known only by the user of a user terminal and a subscribing carrier with a public key of the subscribing carrier, into an information registration request transaction.

### Second Example Embodiment

Next, a second example embodiment of the present invention will be described.

### Task to be Solved by this Example Embodiment

There are number portability DB management methods as described below (for example, see Patent Document 1).

### (1) Individual DB and Telephone Number Range Management Method (Conventional Method 1)

A service provider assigned a telephone number range has a database, manages relocation destination service providers, and accepts inquiries from other service providers. Even in the case of multiple relocations, the number range management service provider manages the history, so that a useless inquiry is not repeated. In Japan, this system is adopted.

### (2) Individual DB and all Companies' Data Retention Method (Conventional Method 2)

A service provider individually operates or a plurality of service providers jointly operate a database for managing all numbers. A service provider using the number registers to all.

### (3) Common DB Method (Conventional Method 3)

A common database is operated with funds contributed by service providers and all routing inquiries are accepted. It is a method adopted in the North American Numbering Plan.

In the conventional method 1, a service provider initially assigned a telephone number range by the government or the like needs to become a number portability DB managing service provider for this telephone number range and, even after the user relocates to another service provider, keep managing the telephone number of this user (Task 1), and also needs to respond to an inquiry about information of the telephone number relocation destination service provider from another service provider (Task 2). The number portability DB management service provider needs to pay a great deal of cost for the above-described operation and has no choice but to charge a fee for responding to an inquiry from another service provider, so that the process gets more complicated, for example, settlement is done between the service providers every time an inquiry is made (Task 3). Moreover, because service providers that manage number portability DB s differ depending on telephone number ranges, the other service providers need to change the destinations of inquiries about information of telephone number relocation destination service providers, depending on telephone number ranges (Task 4). If IoT/M2M becomes more popular in the future and a new number system or the like is introduced (that is, telephone number ranges expand, for example), each service provider needs to construct a number portability DB for each of the expanded telephone number ranges and newly have a database for distributing administration service providers of the DB (Task 5), so that there is concern that the cost of each telecommunications service provider will further increase.

According to the conventional method 1, there are a plurality of number portability DBs depending on telephone number ranges, there are a plurality of DB manager devices likewise, and information registrant devices that register to the DBs and user devices that use information in the DBs access different DB manager devices for the respective telephone number ranges. Moreover, a settlement process between service providers is required so that a usage fee is collected by the DB manager device at the time of use.

The conventional method 2 is a method in which all telecommunications service providers each manage a number portability DB of all telephone numbers individually or jointly as a community of several service providers, and all the service providers and communities needs to pay the cost of maintenance and management of the number portability DB (Task 6). Moreover, although the format of the DB may differ for each service provider and community, the retained content is the same among all the service providers and communities, so that a registrant who registers to the number portability DB needs to notify the registered content to all the service providers and communities (Task 7), which also requires a considerable cost burden for the registrant. On the other hand, in the case of collectively notifying the registered content to all the service providers and communities by broadcasting or multicasting, a registrant does not check reception of the content, so that it cannot be confirmed whether the registered content is reflected to all the service providers and communities (Task 8).

According to the conventional method 2, there are a plurality of DBs all having the same contents regardless of a telephone number range, there are a plurality of DB manager devices likewise, the information registrant devices that register to the DBs register the same content to all the DB manager devices, and the user devices that use the information in the DBs each access its own DB manager device (or the DB manager device of the community to which it belongs) regardless of a telephone number range. Therefore, there is a possibility that a usage fee is not collected from the DB administrator device at the time of use.

The conventional method 3 is advantageous in terms of cost compared with the conventional methods 1 and 2, because a single number portability DB is operated with funds contributed by all the service providers. Moreover, since where to inquire about relocation destination service provider information from a telephone number is only one, it is also cost-effective for an information registrant and a person who inquires. Since it is possible to free inquiry if the cost is coverred with the fund, it is also possible to reduce complicatedness of a process such as settlement between the service providers. However, there is another concern that the single number portability DB becomes a bottleneck, and it is required to increase the processing capacity, reliability, availability and so on of the DB (Task 9), which leads to soaring contributions to the fund.

According to the conventional method 3, there is a single number portability DB regardless of a telephone number range, there is a single DB manager device likewise, registrant devices that register information to the DB register information to the single DB manager device, and user devices that use the information in the DB access the single DB manager device regardless of the telephone number range. Since the single number portability DB and the single DB manager device are operated with funds contributed by all the service providers, there is a possibility that a usage fee is not collected by the DB manager device at the time of use. However, since the single number portability DB and the single DB manager device become bottlenecks, it is required to increase the processing capability, reliability, availability and so on of the DB and the DB manager device.

### Configuration of this Example Embodiment

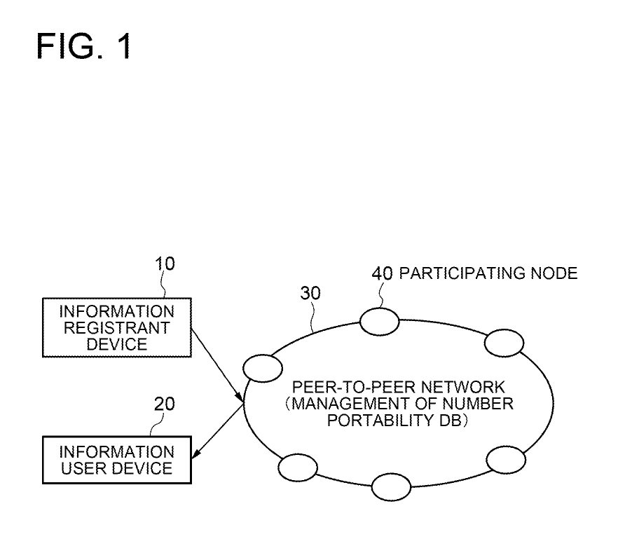

With reference to FIG. 1, this example embodiment includes a plurality of information registrant devices 10 for registering to a number portability DB, a plurality of user devices 20 using information in the number portability DB, and a peer-to-peer network 30 managing a blockchain (a chain of cryptographic hash blocks) handled in Bitcoin, which is one of virtual coins (see Non-Patent Document 2, for example), Ethereum, which is one of smart subscription realization platforms using the distributed ledger technology (see Non-Patent Document 3, for example), or the like.

A number portability DB and a DB manager device in this example embodiment are retained and managed by a plurality of nodes 40 participating in the peer-to-peer network 30. The plurality of nodes 40 participating in the peer-to-peer network 30 may belong to a telecommunications service provider or a community of service providers, or may be an anonymous individual or an anonymous organization not belonging to any organization.

### Operation of this Example Embodiment

Each of the information registrant devices 10 for registering to the number portability DB in this example embodiment broadcasts an information registration request transaction for registering to the number portability DB, to the whole peer-to-peer network 30, and requests information registration.

Each of the nodes 40 participating in the peer-to-peer network 30 verifies an information registration request transaction having been broadcast and, if determining the transaction is valid, generates a new block in which the transaction is combined as a block with another valid information registration request transaction, and adds the new block to the end of the blockchain. A reward to the participating node 40 is paid at the time of verification of an information registration request transaction and generation of a new block.

According to Non-Patent Document 2 and Non-Patent Document 3, a blockchain is made by connecting blocks having been subjected to hash calculation in a chain, and is recorded in a form that a consensus has been built on the validity of the contents among all the nodes participating in the peer-to-peer network 30. Therefore, it is generally said that it is virtually impossible to falsify the content recorded as a blockchain. Moreover, even if a certain node 40 intends to intentionally record wrong information or intends not to record a requested content, the participating nodes 40 as a whole intend to record current content while building a consensus, so that it is generally said that the content recorded as a blockchain is correct.

Each of the user devices 20 that use information in the number portability DB in this example embodiment makes an inquiry about useful information retained by the number portability DB to the peer-to-peer network 30.

### Effect of this Example Embodiment

According to this example embodiment, the number portability DB is managed by all the nodes participating in the peer-to-peer network 30, so that it is possible to solve the tasks 1, 2, 4 and 5 in the conventional method 1 and the tasks 6 and 7 in the conventional method 2.

The task 3 in the conventional method 1 may be solved not by settling an inquiry fee between the telecommunications service providers but by paying as a fee in cryptocurrency or the like to a node executing an inquiry request transaction among the nodes participating in the peer-to-peer network 30. Alternatively, the task may be solved by making a rule in the peer-to-peer network 30 such as collect the fee only at the time of information registration and free the fee at the time of information inquiry.

The task 8 in the conventional method 2 regarding confirmation whether or not reflection of the registered content has succeeded may be solved in a manner that, after the information registrant device 10 for registering to the number portability DB executes an information registration request transaction, the information registrant device 10 issues an inquiry request transaction as the user device 20 using the information in the number portability DB. Alternatively, the task 8 may be solved without confirming whether or not reflection of the registered content has succeeded, by believing that an information registration request transaction certainly succeeds in a consensus building process in the peer-to-peer network 30 at the time of broadcasting the transaction.

The bottleneck of the single DB in the common DB method of the task 9 in the conventional method 3 can be solved because it is covered by all the nodes 40 participating in the peer-to-peer network 30 according to this example embodiment.

### Third Example Embodiment

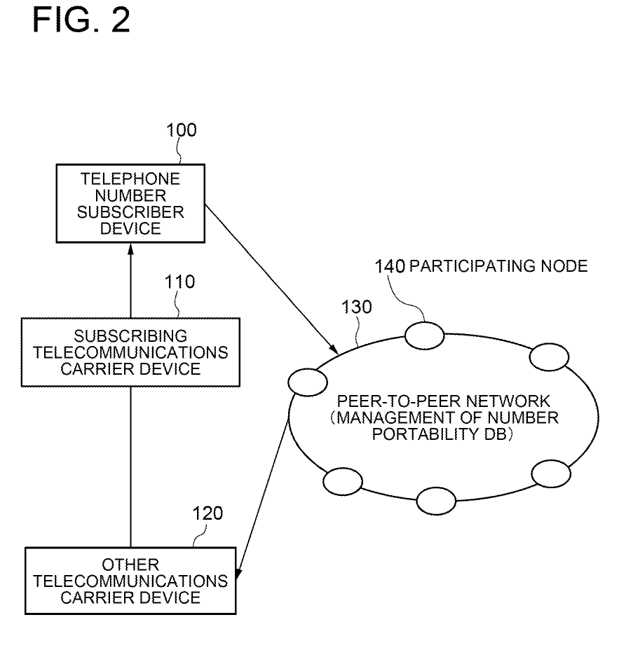

With reference to FIG. 2, this example embodiment includes a telephone number subscriber device 100, a subscribing telecommunications carrier device 110, another telecommunications carrier device 120, and a peer-to-peer network 130 that manages a blockchain (a chain of cryptographic hash blocks) for a number portability DB handled in this example embodiment.

A user subscribing a telephone number generates a private key and public key pair that is managed by the user and retains the pair into the subscriber device 100 of the user. Moreover, the user generates an information registration request transaction that includes a telephone number, subscribing carrier information, a timestamp, an electronic signature obtained by encrypting information including above with a private key and a public key, and broadcasts the transaction to the peer-to-peer network 130 managing the number portability DB in this example embodiment.

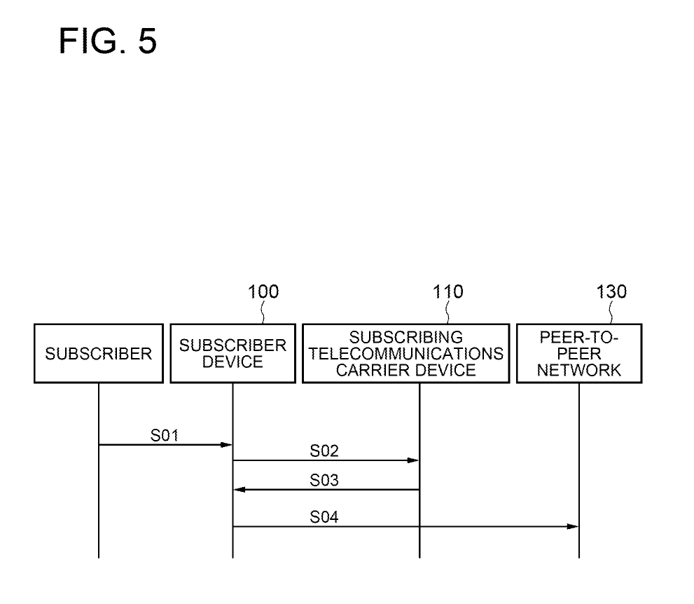

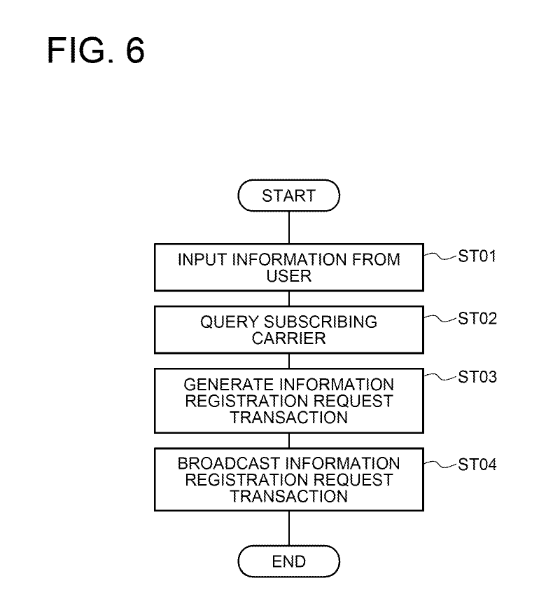

The information registration request transaction may be broadcast via the subscribing telecommunications carrier device 110, but the electronic signature is computed by the subscriber device 100 (for example, a SIM card of a mobile phone, a USB connected to a PC, and the like) because the user's private key is used. This will be described using FIGS. 5 and 6.

FIG. 5 is a signal sequence diagram showing how an information registration request transaction is broadcast from the telephone number subscriber device 100 to the peer-to-peer network 130 managing the number portability DB. FIG. 5 shows how to, after a private key and public key pair, a telephone number and subscribing carrier information are input into the subscriber device 100 and the device 100 obtains access information of the subscribing carrier, an information registration request transaction that includes the above information provided with a timestamp and electronically signed with the private key is broadcast to the peer-to-peer network 130.

In FIG. 5, Signal S01 represents an information input signal input from the subscriber into the subscriber device 100. Signal S01 includes a private key, a public key, a telephone number, and subscribing carrier information (URL, and so on). Signal S02 is an acquisition request signal from the subscriber device 100 for requesting the subscribing telecommunications carrier device 110 to acquire access information of the subscribing telecommunications carrier, and Signal S03 is a signal for responding thereto. Signal S02 includes the telephone number, the URL of the subscribing telecommunications carrier and so on. Signal S03 includes the access information of the subscribing telecommunications carrier. The access information may include information such as a subscription ID that is only known to the subscriber and the subscribing telecommunications carrier. Signal S04 is an information registration request transaction signal which is broadcast from the subscriber device 100 to the peer-to-peer network 130. Signal S04 includes the telephone number, the subscribing carrier information (including the access information acquired in Signal S03), the timestamp, an electronic signature computed by using the above information and the private key, and the public key.

FIG. 6 is a flow diagram how the telephone number subscriber device 100 transmits an information registration request transaction signal to the peer-to-peer network 130 managing the number portability DB. Step ST01 is a step in which the device 100 inputs information from the user, whereby a private key, a public key, a telephone number and subscribing carrier information are input. Step ST02 is a step in which the device 100 queries the subscribing carrier about access information, whereby a subscription ID and so on are obtained based on the telephone number. Step ST03 is a step in which the device 100 generates an information registration request transaction, which includes the telephone number, the subscribing carrier information (including the subscription ID obtained at Step ST02), a timestamp, an electronic signature obtained by encrypting hash values of the above information with the private key, and the public key. Step ST04 is a step in which the device 100 broadcasts the generated information registration request transaction to the peer-to-peer network 130.

All the nodes 140 participating in the peer-to-peer network 130 generate a block by grouping a plurality of information registration request transactions generated during a certain period and hash values thereof as one block, connect all the information registration request transactions of a plurality of blocks for a plurality of periods in the past and hash values of the blocks in a chain (referred to as a blockchain hereinafter), and retains and manages the blockchain as a number portability DB.

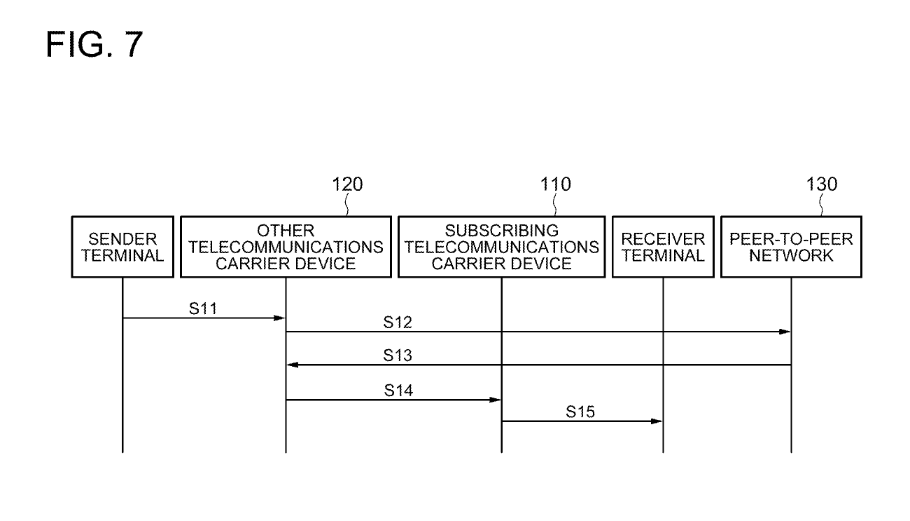

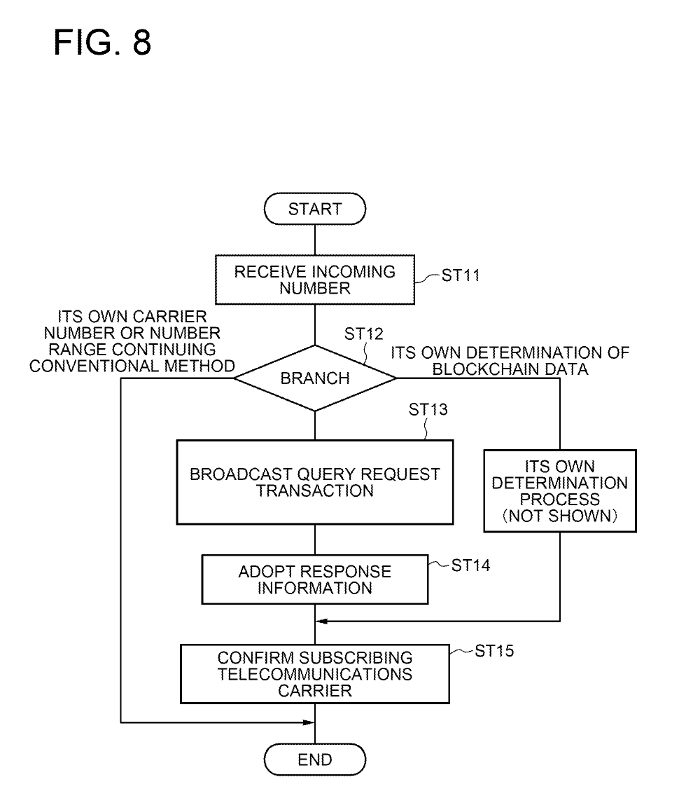

A process that the other telecommunications carrier device 120 (including the subscribing telecommunications carrier device 110), such as a telephone exchange owned by the telecommunications carrier, analyzes a received dial number and acquires information for accessing a subscribing telecommunications carrier (referred to as an incoming number analyzing process hereinafter) is executed by querying the peer-to-peer network 130. To be specific, an information query request transaction is transmitted from the other telecommunications carrier device 120 (including the subscribing telecommunications carrier device 110) to the peer-to-peer network 130 and changed so as to be routed to subscribing telecommunications carrier information of an incoming number in a response signal (or an access destination thereof). This will be described using FIGS. 7 and 8.

FIG. 7 is a signal sequence diagram for incoming number analysis by a telecommunications carrier device (for example, a telephone exchange). Signal S11 is a transmitted signal from a usual subscriber (including a subscribing telecommunications carrier device) to the other telecommunications carrier device 120 and includes a dialed number (a telephone number of a receiver). Signal S12 is an information query request transaction signal broadcast from the other telecommunications carrier device 120 (including the subscribing telecommunications carrier device) to the peer-to-peer network 130. Signal S12 includes the dialed number (the telephone number of the receiver). Signal S13 is a response signal from any node among the nodes 140 participating in the peer-to-peer network 130. The response signal includes subscribing telecommunications carrier information for the telephone number of the receiver. Because a plurality of nodes may return response signals, the other telecommunications carrier device 120 (including the subscribing telecommunications carrier device) adopts information returned by any of the nodes. For adopting, a unique rule may be set, such as adopt a node presenting information selected by majority vote or the like at the earliest as a response node, or adopt information at the time when the number of nodes returning the same information reaches a necessary number at the minimum. Alternatively, a rule of paying some fee to an adopted node or a node providing adopted information may also be set. Alternatively, the other telecommunications carrier device 120 (including the subscribing telecommunications carrier device) may previously obtain a copy of all information of a blockchain at a constant period at all times and find subscribing telecommunications carrier information regarding a telephone number of a receiver instead of

Signals S12 and S13. Signal S14 is a transfer signal in communication between usual telecommunications carriers. In a case where information unique to number portability of the conventional method (information for settlement between service providers, access information of a number relocation destination, and so on) is included in the signal, it is corrected so as to conform to this example embodiment. Signal S15 is a usual incoming signal from the subscribing telecommunications carrier device 110 to a number portability subscriber terminal (a receiver terminal).

FIG. 8 is a flow diagram showing how, in the incoming number analysis process, the other telecommunications carrier device 120 (including the subscribing telecommunications carrier device) broadcasts a query request transaction to the peer-to-peer network 130 managing the number portability DB and confirms subscribing telecommunications carrier information with respect to an incoming telephone number. Step ST11 is a step in which the telecommunications carrier device 120 receives a receiver's telephone number. Step ST12 is a process branching step. The process is branched into, for example: a case where the telecommunications carrier device knows whether or not the receiver's telephone number is a number of a subscription to the telecommunications carrier itself or a case where the telecommunications carrier device knows that the receiver's telephone number is managed by using the number portability DB of the conventional method (left branch in FIG. 8); a case where the telecommunications carrier device regularly loads the latest blockchain data and obtains the subscribing telecommunications carrier information of the receiver's telephone number (right branch in FIG. 8); and a case where the telecommunications carrier device broadcasts a query request transaction to the peer-to-peer network 130 (center branch in FIG. 8). Step ST13 is a step in which the telecommunications carrier device 120 broadcasts a query request transaction for querying about subscribing telecommunications carrier information corresponding to the receiver's telephone number to the peer-to-peer network 130. Step ST14 is a step in which the telecommunications carrier device 120 waits for response signals to the broadcast signal and adopts any response content and response node from among them. Step ST15 is a step in which the telecommunications carrier device 120 confirms subscribing telecommunications carrier information with respect to the receiver's telephone number having been received. To Step ST15, a blockchain data unique determination process (not shown) also comes, which is the right branch at Step ST12 in FIG. 8.

Further, not only in the incoming number analysis process but also in an outgoing number analysis process such as a charge number query at the time of transmission, the process to query the number portability DB of the conventional method may be modified so as to query the peer-to-peer network 130.

The incoming number analysis process and the outgoing number analysis process may be limited to only a new telephone number range that may be newly set as one for IoT/M2M in the future in Japan, where number portability has already been realized by the conventional method 1. However, such a limitation is not necessarily required in foreign countries, where number portability has already been realized by the conventional method 2 or 3.

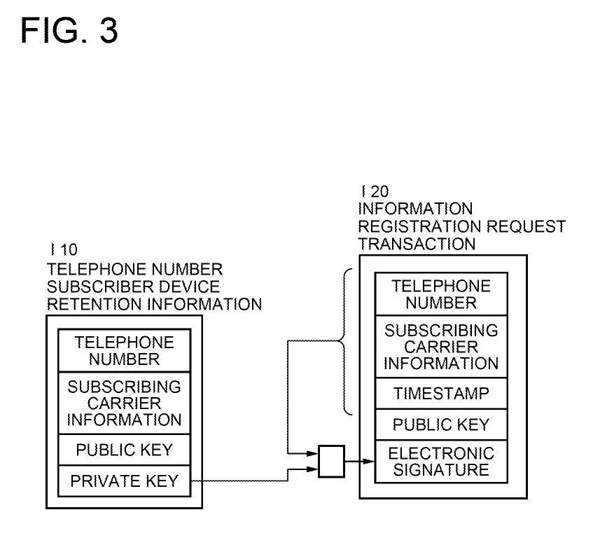

FIG. 3 is an information component diagram showing a relation between information I10 retained by a telephone number subscriber device and the content of an information registration request transaction I20 to a number portability DB.

Regarding an information registration request transaction broadcast in this example embodiment, the validity thereof is verified by all the nodes 140 participating in the peer-to-peer network 130, and success or failure of recording to a blockchain is confirmed through a consensus building process by all the nodes.

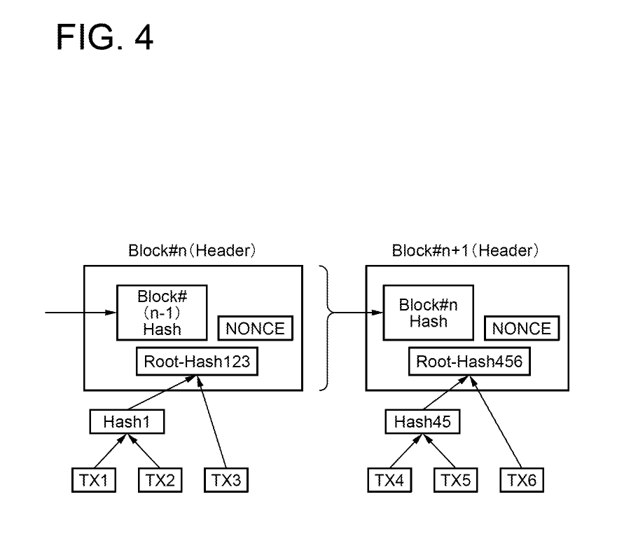

FIG. 4 is an information component diagram showing a relation of contents between a plurality of transactions and the content of a plurality of blocks in a blockchain. Each TX denotes an information registration request transaction. Each Hash is a hash value returned from a cryptographic hash function of two transactions. Each participating node 140 computes hashes of all the transactions during one block generation period and, until one Root-Hash value (also referred to as a Merkle-Root value) is obtained in the end, repeats verification of the validity of transactions and computation of hash values. At a block generation time, each participating node 140 computes a hash value of a new block by using a hash value of a block having been broadcast during a previous block generation time (or hash values of all the previous blocks including the last block recalculated by itself) and a Root-Hash value generated from information registration request transactions newly generated during a current block generation period. At that time, a hash value of a new block is obtained while adjusting a NONCE value or the like so that the hash value of the new block becomes a value based on a rule in a consensus building process defined in the peer-to-peer network specification, and broadcasts to the peer-to-peer network 130.

Since the participants 140 of the peer-to-peer network 130 are forced to provide a large amount of computer power for cryptographic hash calculation, verification of the validity of a transaction, generation of a blockchain and so on, motivation for maintaining the network is necessary. That is, a certain commission is required.

In Non-Patent Document 2, predetermined bitcoins are given to a person who has succeeded in overcoming competition for hash calculation of a new block obtained by bundling transactions for the purpose of, for example, trade (transfer of the owner) of Bitcoin, which is a cryptocurrency, and in recording to the end of the blockchain. This is called coin mining. At present, a new block is generated at about ten-minute intervals and 25 bitcoins are mined. The amount of coins to be mined every ten minutes decreases by half once every four years. Mined coins do not affect the issuer of a transaction. In addition to coin mining, it is also possible to include an extra commission from the issuer of a transaction into the transaction (transfer the owner of bitcoins for the commission). It is also possible to define a different cryptocurrency, a multipurpose point or the like on the base of Bitcoin.

In Non-Patent Document 3, predetermined ethers are given to a person who has succeeded in overcoming competition for hash calculation of a new block obtained by bundling transactions relating to conclusion of a smart contract (a contract that can be confirmed by a computer) and performance of the contract (a code that can be automatically executed by a computer), not limited to trade (transfer of the owner) of Ether, which is a cryptocurrency of Ethereum, and in recording to the end of the blockchain (referred to as a mining successor hereinafter). A reward given to a mining successor includes 5 ethers fixed per mining and ethers corresponding to the amount of transaction information and fuel (Gas) defined in Ethereum necessary for executing a contract fulfillment code, collected from the transaction issuer.

In this example embodiment, an information registration request transaction approval fee for recording to a blockchain for a number portability DB is paid in the same way as these virtual currencies or by using a separately determined cryptocurrency, multipurpose point or the like.

The above-described consensus building process is carried out with competition for cryptographic hash calculation at the time of update of a blockchain or with a consensus building rule exclusive for a peer-to-peer network defined separately.

Distribution of the approval fee to the nodes participating in the peer-to-peer network is done by winners who has overcome competition for cryptographic hash calculation or based on a separately defined consensus building rule.

The information registrant devices 10 in the second example embodiment or the telephone number subscriber device 100, the subscribing telecommunications carrier device 110, the other telecommunications carrier device 120 and the number management bureau device in the third example embodiment do not concern a consensus building process or rule or a method for allocating the approval fee, but are able to simply confirm whether a transaction issued by itself has succeeded or not by a registration information confirmation method as the user devices 20 using information in the DB described in the second example embodiment of the present invention, but the confirmation is not necessarily required. That is, at the time of broadcasting the information registration request transaction, confirmation is unnecessary if it is believed that the transaction has succeeded by the network consensus building process, of the peer-to-peer network, but any confirmation is possible unless it is not immediately believed.

A blockchain is obtained by cryptographic hash calculation of a plurality of transactions issued in the past and a plurality of blocks generated in the past, and all the nodes 140 participating in the peer-to-peer network 130 retain the same information through a consensus building process, so that falsification such as change and deletion is practically impossible. In a case where a certain node 140 intends to falsify past data, the node 140 needs to redo hash calculation of a transaction which the node wants to falsify and a block retaining the transaction and all transactions generated after that and hash calculation of all blocks generated after that, and continue to overcome competition for cryptographic hash calculation or keep showing that there is no inconsistency on the consensus building process against all the other participating nodes 140. Whether the falsification succeeds or not depends on superiority and inferiority between computer power of the node which the node wants to falsify and the total value of computer power of all the other participating nodes. As block generation progresses, the probability that a malicious node continues to win will drop dramatically, so that any falsification of the blockchain will be found in the near future and replaced with another valid blockchain. This means that a blockchain cannot be falsified virtually.

Therefore, update and deletion of a number portability DB according to the present invention in a case where a number portability user relocates to another telecommunications carrier or terminates a telephone number subscription is done in the form of broadcasting a transaction in which change of relocation destination information with a telephone number as a main key (a public key of a number license holder, subscribing carrier information) is described and editing a blockchain through the above-described consensus building process.

### Fourth Example Embodiment

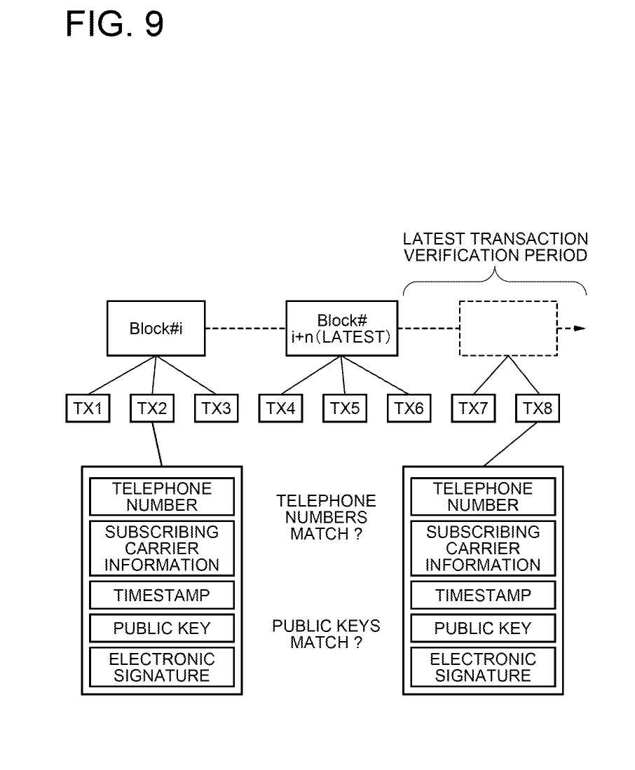

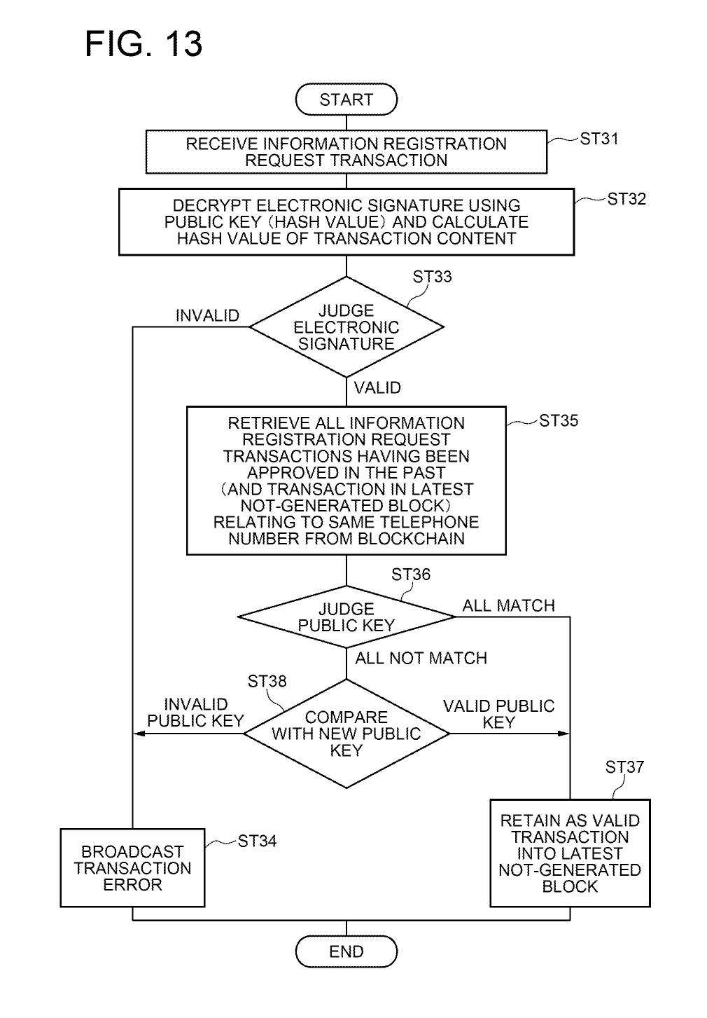

This example embodiment describes a number portability management system which is robust against an attack such that a malicious third party who knows another person's telephone number generates any private key and public key pair and broadcasts a fake information registration request transaction. Hereinafter, the configuration and operation of this example embodiment will be described with reference to FIGS. 9 and 13.

FIG. 13 is a flowchart showing an example of processing by a node participating in a peer-to-peer network. The processing shown in FIG. 13 is equivalent to, for example, processing executed by the blockchain management part 2g of the node device 2a shown in FIG. 38.

With reference to FIG. 13, upon receiving an information registration request transaction broadcast by the information registrant device 3 (ST31), the blockchain management part 2g decrypts an electronic signature included in the received information registration request transaction by using a public key included in the received information registration request transaction, and calculates a hash value from the content (in the case shown in FIG. 3, a telephone number, subscribing carrier information, and a timestamp) of the received information registration request transaction (ST32). Next, the blockchain management part 2g compares the hash value obtained by decrypting the electronic signature with the generated hash value and thereby judges the validity of the electronic signature (S T33). Next, in a case where the electronic signature is invalid, the blockchain management part 2g treats the currently received information registration request transaction as an invalid transaction and broadcasts a transaction error to the peer-to-peer network (ST34).

On the other hand, in a case where the electronic signature is valid, the blockchain management part 2g retrieves, from the blockchain, all the previously approved information registration request transactions (and transactions in the latest not-generated block) relating to the same telephone number as the telephone number included in the currently received information registration request transaction (ST35). Next, the blockchain management part 2g judges, based on the public key included in the currently received information registration request transaction and public keys included in the information registration request transactions retrieved at Step ST35, whether all the public keys match, that is, only one kind of public key exists, or the public keys do not match, that is, a public key which does not match another public key is present (ST36). In a case where all the public keys match, the blockchain management part 2g treats the currently received information registration request transaction as a valid transaction and retains the transaction in the latest not-generated block (ST37).

On the other hand, if the public keys do not match, the blockchain management part 2g compares the public key included in the currently received information registration request transaction with a new public key to be described in a fifth example embodiment (ST38). If the public key included in the currently received information registration request transaction matches the new public key, the blockchain management part 2g treats the currently received information registration request transaction as a valid transaction and retains the transaction in the latest not-generated block (ST37). However, if the public key included in the currently received information registration request transaction does not match the new public key, the blockchain management part 2g treats the currently received information registration request as an invalid transaction and broadcasts a transaction error to all the peer-to-peer network (ST34).

FIG. 9 is a conceptual diagram showing an example the processing at steps ST35 and ST36. In FIG. 9, TX8 is a currently received information registration request transaction, TX1 to TX7 are previously approved information registration request transactions (and transaction in the latest not-generated block). Moreover, the information registration request transaction TX2 is a transaction including the same telephone number as a telephone number included in the information registration request transaction TX8. The blockchain management part 2g compares the public keys of the information registration request transactions TX2 and TX8 and, if the public keys match, treats the currently received information registration request transaction as a valid transaction.

### Fifth Example Embodiment

In this example embodiment, a number portability information management system configured to be able to change a private key and public key pair and change a telecommunications carrier will be described.

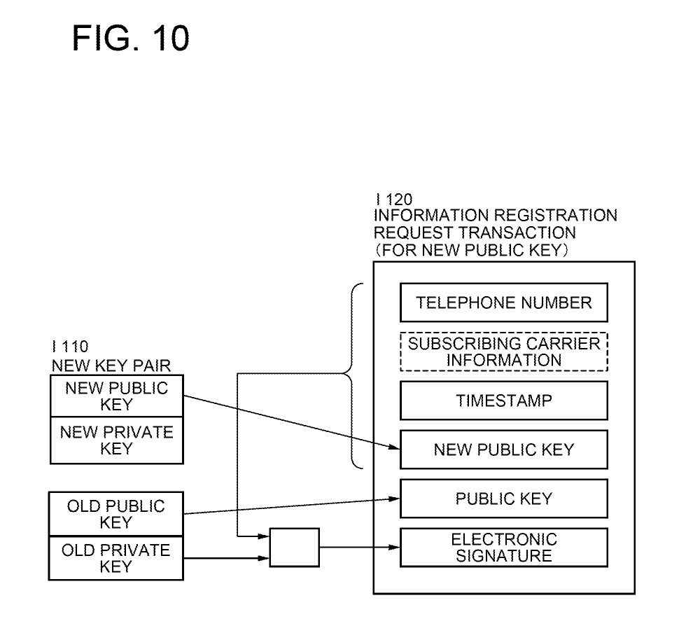

In general, it is assumed that a legitimate telephone number license holder updates a private key and public key pair as general operation. Alternatively, it is assumed that, as usual operation, a legitimate telephone number license holder abandons a telephone number license or transfers the license including a telecommunications carrier to another person. In order to deal with the above, this example embodiment solves by broadcasting a content in which a public key of a legitimate license holder with respect to a telephone number (or a number range or a plurality of discontinuous numbers) is added as a public key of a number license holder (hereinafter, referred to as a new public key) to an information registration request transaction to a peer-to-peer network only once (or every time the public key updated or every time a number license is transferred). The configuration and operation of this example embodiment will be described with reference to FIGS. 10, 11, 12 and 13.

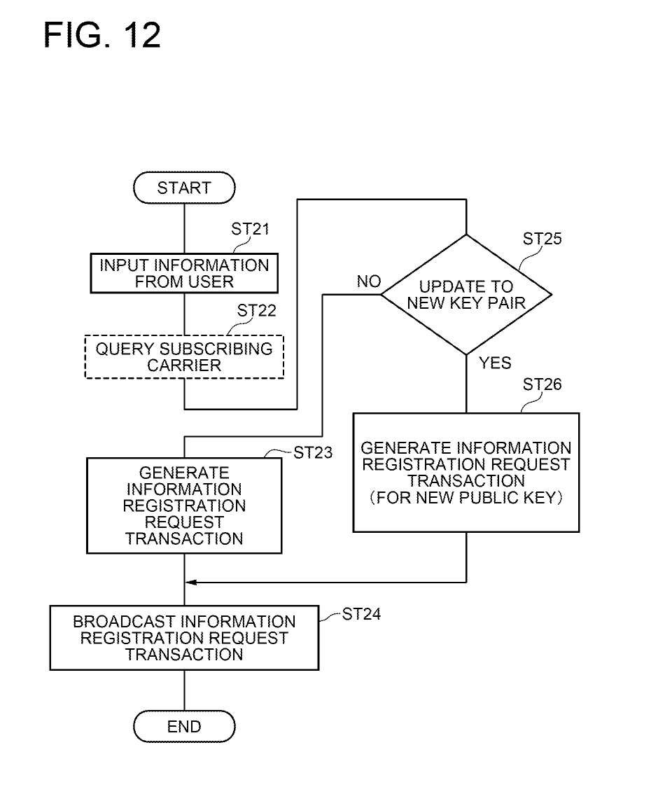

FIG. 12 is a flow diagram showing how the telephone number subscriber device 100 transmits an information registration request transaction signal is transmitted to the peer-to-peer network 130 managing the number portability DB. Step ST21 is a step in which the device 100 inputs information from the user, where a private key, a public key, a telephone number and subscribing carrier information are input. Step ST22 is a step in which the device 100 queries a subscribed carrier about access information, and a subscription ID or the like is obtained from the telephone number. This Step ST22 may be omitted. Step ST25 is a step in which it is determined whether or not to update to a new key pair. Step ST23 is a step for generating an information registration request transaction in the case of not updating to a new key pair, and is the same as ST03 shown in FIG. 6. Step ST26 is a step for generating an information registration request transaction in the case of updating to a new key pair. Step ST24 is a step for broadcasting the information registration request transaction generated at Step ST23 or Step ST26 to the peer-to-peer network 130.

FIG. 10 is an explanatory diagram of Step ST26 for generating an information registration request transaction in the case of updating to a new key pair. An information registration request transaction (for a new public key) includes a telephone number, subscribing carrier information, a timestamp, a new public key, an old public key, and an electronic signature. The electronic signature is to sign the telephone number, the subscribing carrier information, the timestamp and the new public key with the old private key. The subscribing carrier information may be omitted.

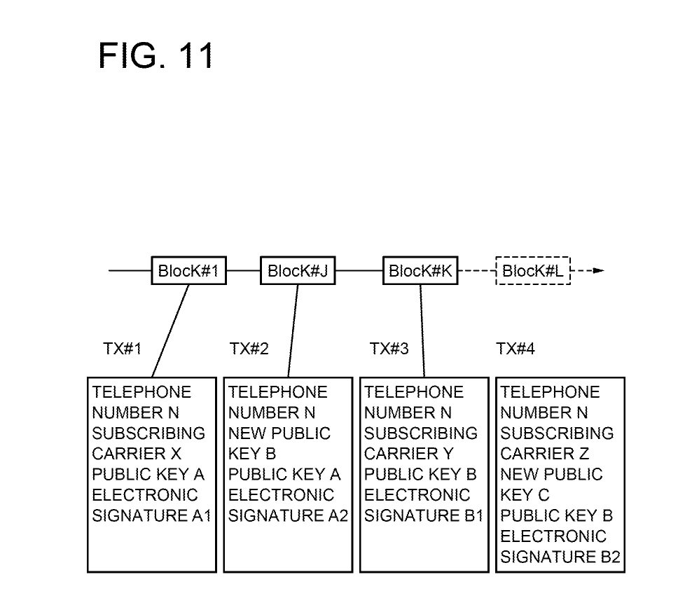

FIG. 11 shows an example of a plurality of information registration request transactions TX#1 to TX#4 relating to the same telephone number accumulated in a blockchain of a certain node. The information registration request transaction TX#1 includes an electronic signature A1 which is a signature with a public key A on information including a telephone number N and a subscribing carrier X. The information registration request transaction TX#2 is a transaction for updating the key pair and includes an electronic signature A2 which is a signature with the public key A on information including the telephone number N and a new public key B. Because the subscribing carrier X does not change, the information of the subscribing carrier X is omitted in the information registration request transaction TX#2. The information registration request transaction TX#3 is a transaction for updating the subscribing carrier and includes an electronic signature B1 which is a signature with a public key B on information including the telephone number N and a new subscribing carrier Y. The information registration request transaction TX#4 is a transaction for updating both the key pair and the subscribing carrier and includes an electronic signature B2 which is a signature with the public key B on information including the telephone number N, a new subscribing carrier Z and a new public key C.

FIG. 13 is a flowchart showing an example of processing by a node participating in a peer-to-peer network. As described before, the processing shown in FIG. 13 is equivalent to, for example, the processing executed by the blockchain management part 2g of the node device 2a shown in FIG. 38. Because the flow of the whole processing shown in FIG. 13 has already been described, a flow in a scene of processing the information registration request transactions TX#2 to TX#4 shown in FIG. 11 will be described below.

In a scene where the information registration request transaction TX#2 is received, an already registered transaction including the same telephone number N is only TX#1. At this time, when judging that the electronic signature A2 is valid, the blockchain management part 2g retrieves the transaction TX#1 (ST35) and, since the public keys match between the transactions TX#1 and TX#2, retains the transaction TX#2 as a valid transaction in the latest not-generated block (ST37). Since the transaction TX#2 includes the new public key B, the public key B is treated as a valid public key afterward.

Next, in a scene where the information registration request transaction TX#3 is received, already registered transactions including the same telephone number N are two transactions TX#1 and TX#2. At this time, when judging that the electronic signature B1 is valid, the blockchain management part 2g retrieves the transactions TX#1 and TX#2 (ST35) and, since the public keys do not match among the transactions TX#1 to TX#3, compares the public key B included in the transaction TX#3 with the currently valid new public key B (ST38). Since the public keys match consequently, the blockchain management part 2g retains the transaction TX#3 as a valid transaction in the latest not-generated block (ST37). Since the transaction TX#3 includes a new subscribing carrier Y, the subscribing carrier Y is treated as a valid subscribing carrier afterward.

Next, in a scene where the information registration request transaction TX#4 is received, already registered transactions including the same telephone number N are three transactions TX#1 to TX#3. At this time, when judging that the electronic signature B2 is valid, the blockchain management part 2g retrieves the transactions TX#1 to TX#3 (ST35) and, since the public keys do not match among the transactions TX#1 to TX#4, compares the public key B included in the transaction TX#4 with the currently valid new public key B (ST38). Since the public keys match consequently, the blockchain management part 2g retains the transaction TX#4 as a valid transaction in the latest not-generated block (ST37). Since the transaction TX#3 includes a new public key C and a new subscribing carrier Z, the public key C is treated as a valid public key afterward and the subscribing carrier Z is treated as a valid subscribing carrier afterward.

### Sixth Example Embodiment

In this example embodiment, a number portability management system which is robust against an attack such that, for the purpose of seizing a license of any telephone number (or number range or discontinuous numbers) having never been used, a malicious third party generates any private key and public key pair and firstly broadcasts an information registration request transaction including the new public key will be described.

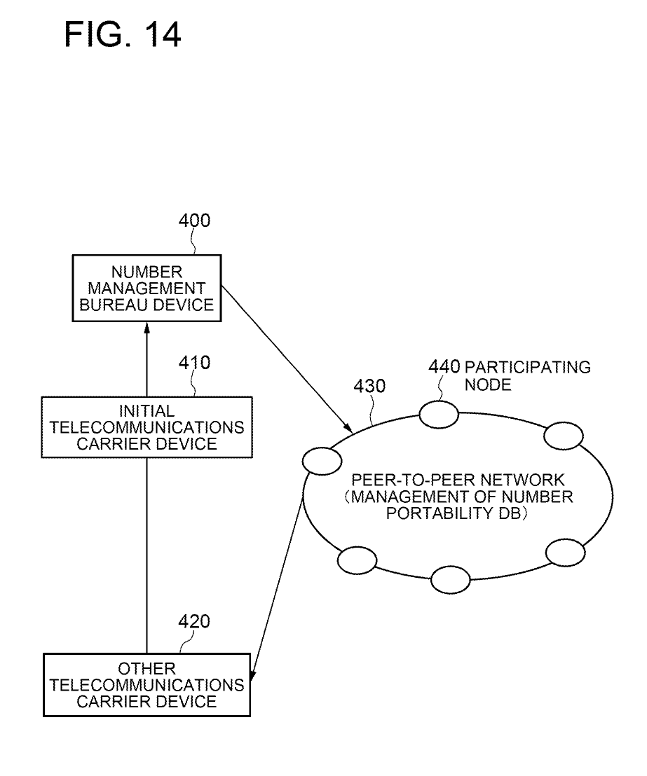

In this example embodiment, an initial licensee of a number range (referred to as the initial telecommunications carrier hereinafter) is decided by the administration or an authority such as a number management bureau outsourced by the administration (referred to as the number management bureau hereinafter), and an initial information registration request transaction including a new public key for any telephone number (or number range or discontinuous numbers) is broadcast by a device of the number management bureau, or a device of the initial telecommunications carrier, or a user who has legitimately contracted with the initial telecommunications carrier. It is needless to say that public keys and electronic signatures included in transactions vary depending on transmitters of broadcast signals. A “new public key” included in a transaction includes a public key of a person approved as a legitimate number licensee by the transmitter of the transaction. Hereinafter, the configuration and operation of this example embodiment will be described with reference to FIGS. 14 to 30.

First, a configuration that an initial information registration request transaction including a new public key for any telephone number (or number range or discontinuous numbers) is broadcast by a number management bureau device will be described with reference to FIGS. 14 to 17.

With reference to FIG. 14, the system includes a number management bureau device 400, an initial telecommunications carrier device 410, another telecommunications carrier device 420, a peer-to-peer network 430 that manages a blockchain for a number portability DB, and a plurality of nodes 440 participating in the peer-to-peer network 430.

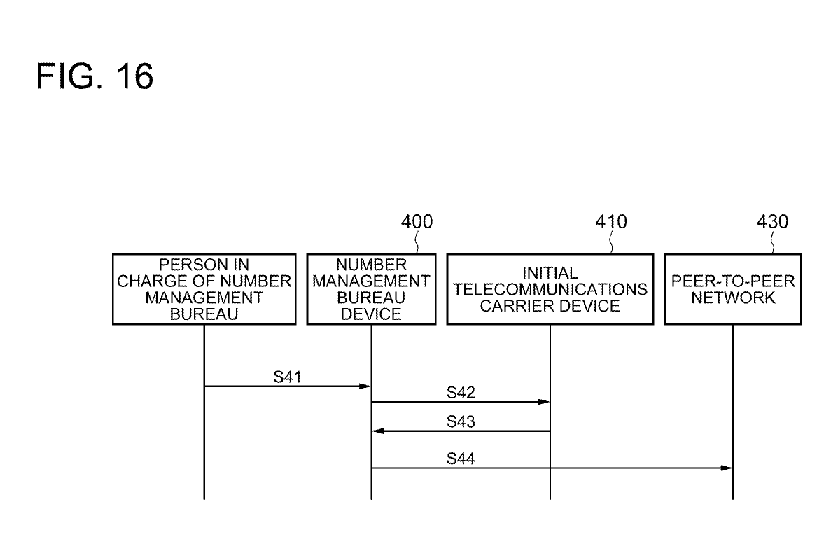

FIG. 16 is a signal sequence diagram showing how an information registration request transaction is broadcast from the number management bureau device 400 to the peer-to-peer network 430 managing the number portability DB. FIG. 16 shows how, after a person in charge of the number management bureau inputs necessary information into the number management bureau device 400 and the device 400 acquires necessary information from an initial subscribing carrier device, an information registration request transaction generated by providing the above-described information with a timestamp and electronically signing with a private key is broadcast to the peer-to-peer network 430.

In FIG. 16, Signal S41 represents an information input signal from the person in charge of the number management bureau to the number management bureau device 400. Signal S41 includes a private key and public key pair of the number management bureau and subscribing carrier information (URL, or the like). Signal S42 is a signal to request outsourcing of number range management and acquisition of a public key of the telecommunications carrier, sent from the number management bureau device 400 to the initial telecommunications carrier device 410, and Signal S43 is a response signal thereto. Signal S42 includes the URL of the subscribing telecommunications carrier, or the like. Signal S43 includes the telephone number range (or discontinuous numbers), or the like. Signal S44 is an information registration request transaction signal broadcast from the number management bureau device 400 to the peer-to-peer network 430.

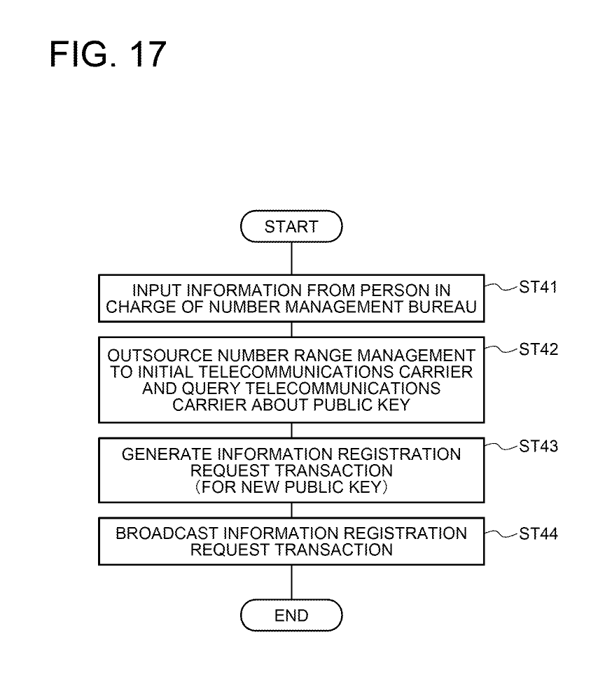

FIG. 17 is a flow diagram how the number management bureau device 400 transmits an information registration request transaction signal to the peer-to-peer network 430 managing the number portability DB. Step ST41 is a step in which the device 400 inputs the above-described information from the person in charge of the number management bureau. Step ST42 is a step in which the device 400 queries the initial telecommunications device 410 about the above-described information. Step ST43 is a step in which the device 400 generates an information registration request transaction (for a new public key). Step ST44 is a step in which the device 400 broadcasts the generated information registration request transaction to the peer-to-peer network 430.

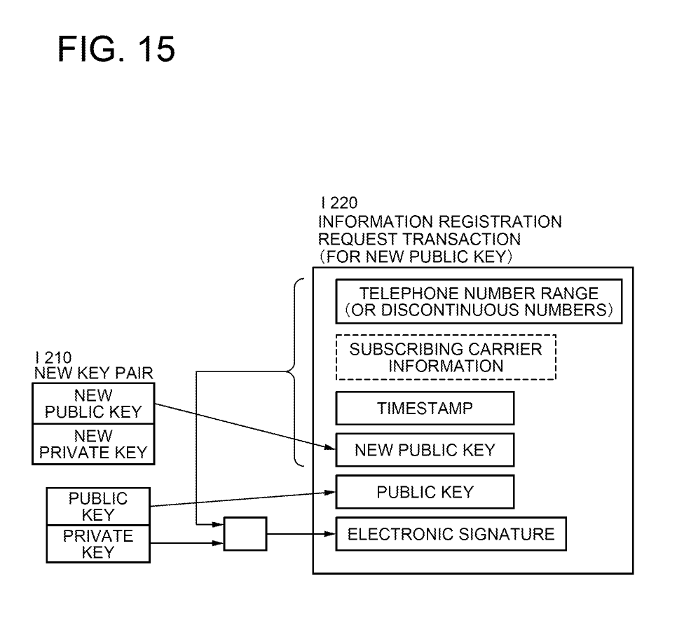

FIG. 15 is an explanatory diagram of Step ST43 for generating an information registration request transaction (for a new public key). An information registration request transaction (for a new public key) I220 includes a telephone number range (or a plurality of discontinuous numbers), subscribing carrier information, a timestamp, a new public key, a public key, and an electronic signature. The electronic signature is a signature with a private key on the telephone number range (or the plurality of discontinuous numbers), the subscribing carrier information, the timestamp, and the new public key.

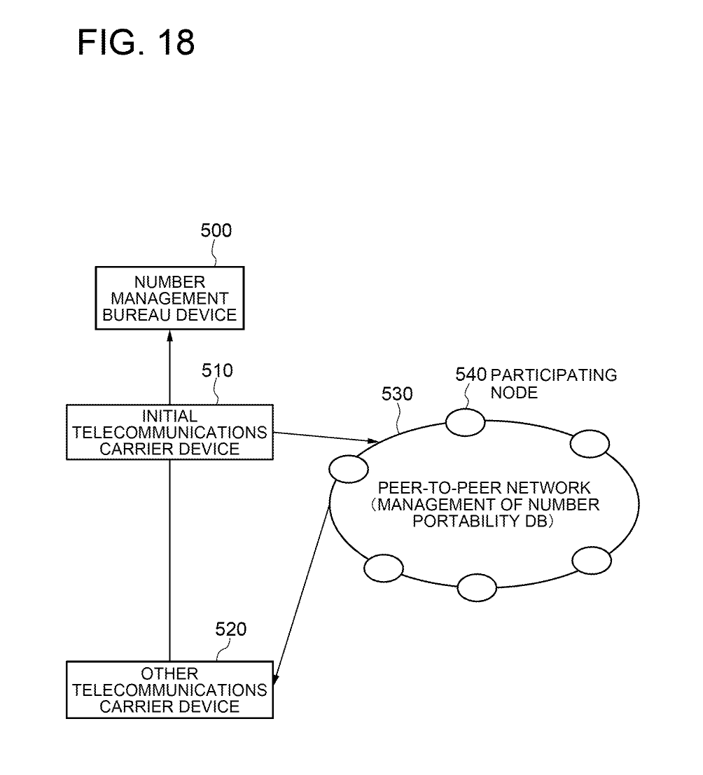

Next, a configuration in which an initial telecommunications carrier broadcasts an initial information registration request transaction including a new public key for any telephone number (or number range or discontinuous numbers) will be described with reference to FIGS. 18 to 21.

With reference to FIG. 18, the system includes a number management bureau device 500, an initial telecommunications carrier device 510, another telecommunications carrier device 520, a peer-to-peer network 530 managing a blockchain for a number portability DB, and a plurality of nodes 540 that participate in the peer-to-peer network 530.

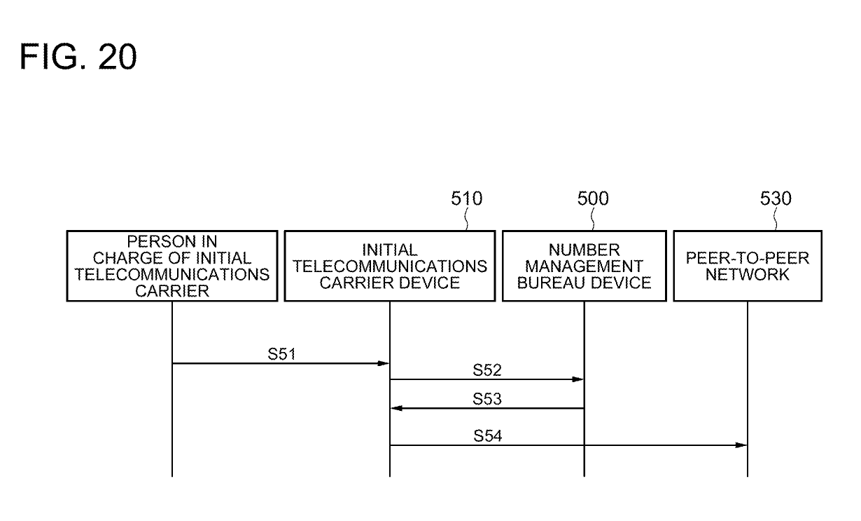

FIG. 20 is a signal sequence diagram showing how an information registration request transaction is broadcast from the initial telecommunications carrier device 510 to the peer-to-peer network 530 managing the number potability DB. FIG. 20 shows how, after a person in charge of the initial telecommunications carrier inputs necessary information into the initial telecommunications carrier device 510 and the device 510 acquires necessary information from the number management bureau device 500, an information registration request transaction generated by providing the above-described information with a timestamp and electronically signing with a private key is broadcast to the peer-to-peer network 530.

In FIG. 20, Signal S51 represents an information input signal that is input by the person in charge of the initial telecommunications carrier into the initial telecommunications carrier device 510. Signal S51 includes a private key and public key pair of the initial telecommunications carrier device and information (URL, or the like) of the number management bureau device. Signal S52 is a signal to request acquisition of a number range outsourcing certificate, sent from the initial telecommunications carrier device 510 to the number management bureau device 500, and Signal S53 is a signal of response to the request. Signal S52 includes the URL or the like of the number management bureau device. Signal S53 includes the number range outsourcing certificate. Signal S54 is an information registration request transaction signal that is broadcast by the initial telecommunications carrier device 510 to the peer-to-peer network 530.

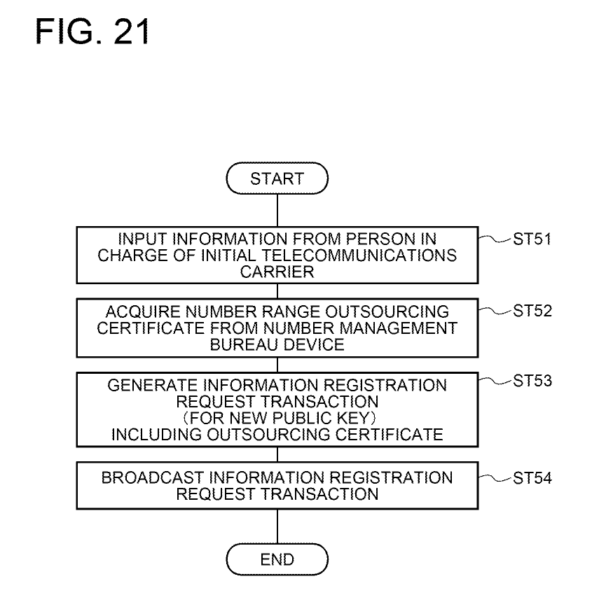

FIG. 21 is a flow diagram showing how the initial telecommunications carrier device 510 transmits an information registration request signal to the peer-to-peer network 530 managing the number portability DB. Step ST51 is a step in which the device 510 inputs the above-described information input by the person in charge of the telecommunications carrier. Step ST52 is a step in which the device 510 queries the number management bureau device 500 about the above-described information. Step ST53 is a step in which the device 510 generates an information registration request transaction (for a new public key). Step ST54 is a step in which the device 510 broadcasts an information registration request transaction to the peer-to-peer network 530.

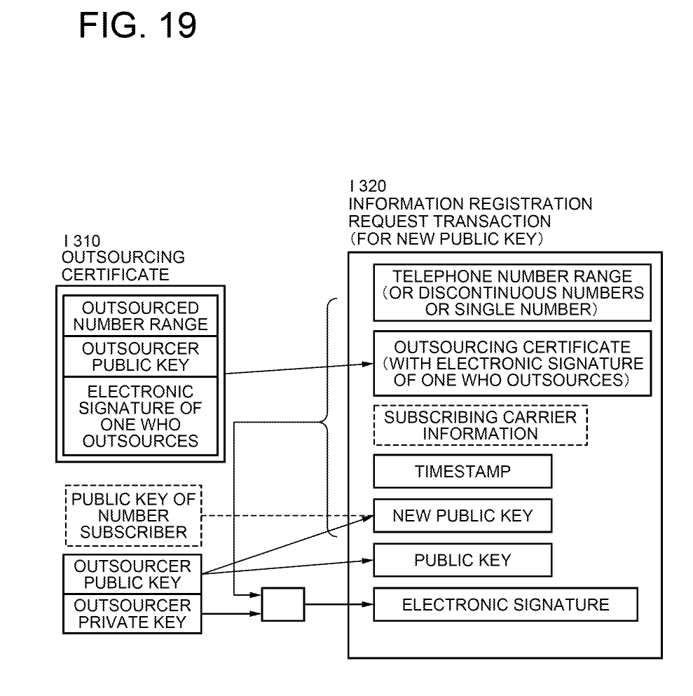

FIG. 19 is an explanatory diagram of Step ST53 for generating an information registration request transaction (for a new public key). An information registration request transaction (for a new public key) I320 includes a telephone number range (or discontinuous numbers or a single number), an outsourcing certificate (with an electronic signature of one who outsources), subscribing carrier information, a timestamp, a new public key (an outsourcer public key), a public key (an outsourcer public key), and an electronic signature. An outsourcing certificate I310 includes an outsourced number range, an outsourcer public key, and an electronic signature of one who outsources. The electronic signature included in the transaction is a signature with an outsourcer private key on the telephone number range (or discontinuous numbers or single number), the outsourcing certificate (with the electronic signature of one who outsources), the subscribing carrier information, the timestamp, and the new public key (outsourcer public key). The subscribing carrier information may be omitted. As the new public key, a public key of a number subscriber may be used.

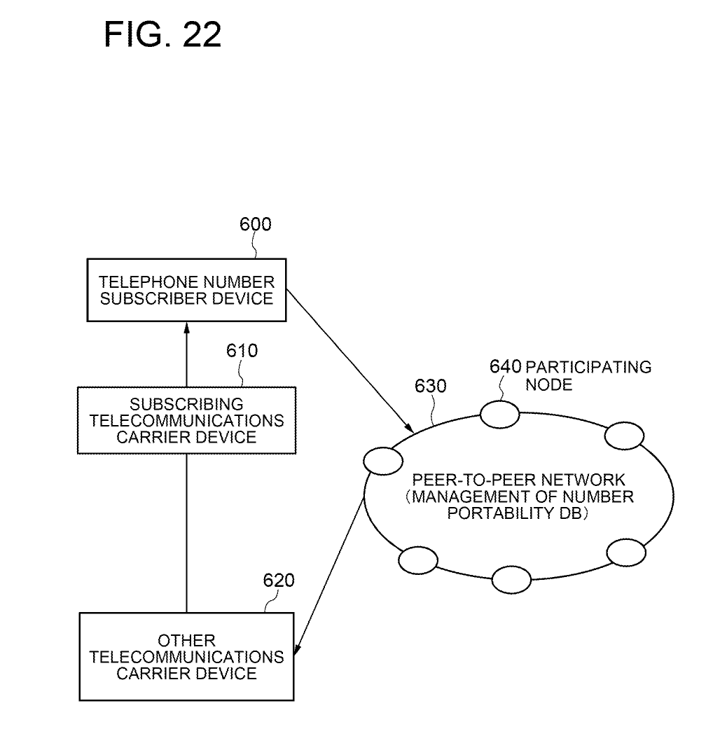

Next, a configuration in which an initial information registration request transaction including a new public key for any telephone number (or number range or discontinuous numbers) is broadcast from a user who has legitimately contracted with the initial telecommunications carrier will be described with reference to FIGS. 22 to 25.

With reference to FIG. 22, the system includes a telephone number subscriber device 600, a subscribing telecommunications carrier device 610, another telecommunications carrier device 620, a peer-to-peer network 630 managing a blockchain for a number portability DB, and a plurality of nodes 640 participating in the peer-to-peer network 630.

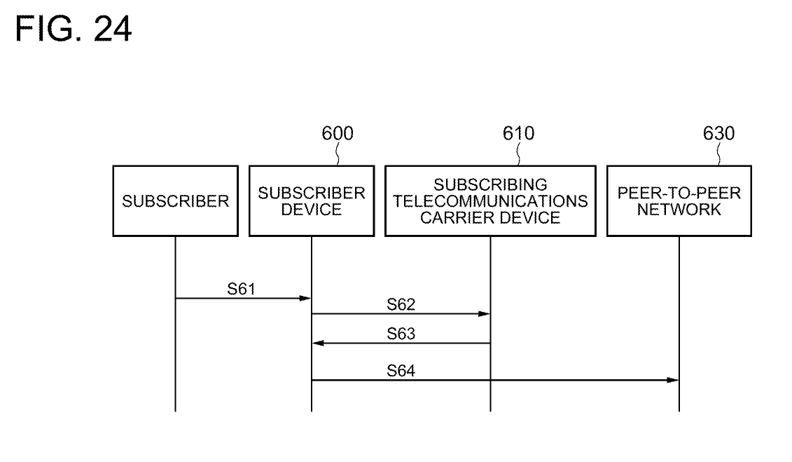

FIG. 24 is a signal sequence diagram showing how the subscriber device 600 broadcasts an information registration request transaction to the peer-to-peer network 630 managing the number portability DB. FIG. 24 shows how, after a subscriber inputs necessary information into the subscriber device 600 and the device 600 acquires necessary information from the subscribing telecommunications carrier device 610, an information registration request transaction generated by providing the above-described information with a timestamp and electronically signing with a private key is broadcast to the peer-to-peer network 630.

In FIG. 24, Signal S61 represents an information input signal that is input by the subscriber into the subscriber device 600. Signal S61 includes a private key and public key pair of the subscriber and information (URL or the like) of the subscribing telecommunications carrier 610. Signal S62 is a signal to request acquisition of subscribing carrier information, a subcontract certificate and so on, sent from the subscriber device 600 to the subscribing telecommunications carrier device 610, and Signal S63 is a response signal thereto. Signal S62 includes the URL or the like of the subscribing telecommunications carrier device. Signal S63 includes a subcontract certificate (and an outsourcing certificate). Signal S64 is an information registration request transaction signal that is broadcast from the subscriber device 600 to the peer-to-peer network 630.

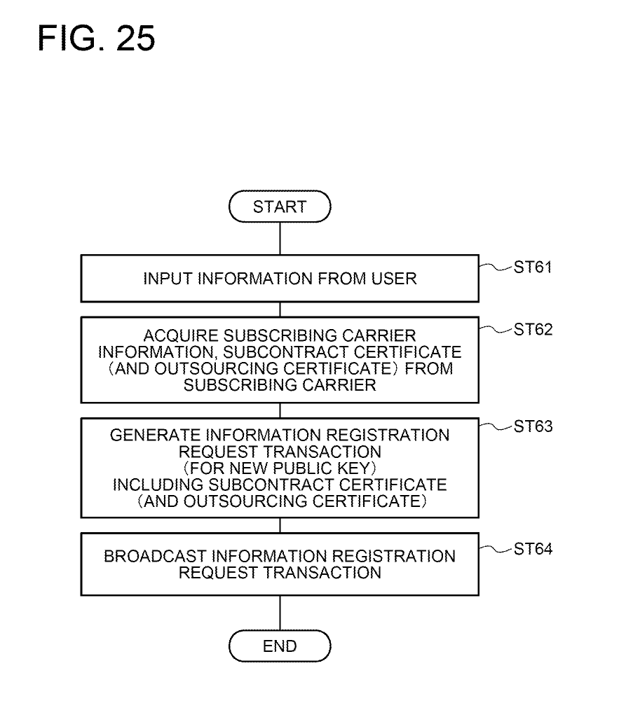

FIG. 25 is a flow diagram showing how the subscriber device 600 transmits an information registration request signal to the peer-to-peer network 630 managing the number portability DB. Step ST61 is a step in which the device 600 inputs the above-described information input by the user. Step ST62 is a step in which the device 600 queries the subscribing telecommunications carrier device 610 about the above information. Step ST63 is a step in which the device 600 generates an information registration request transaction (for a new public key). Step ST64 is a step in which the device 600 broadcasts the generated information registration request transaction to the peer-to-peer network 630.

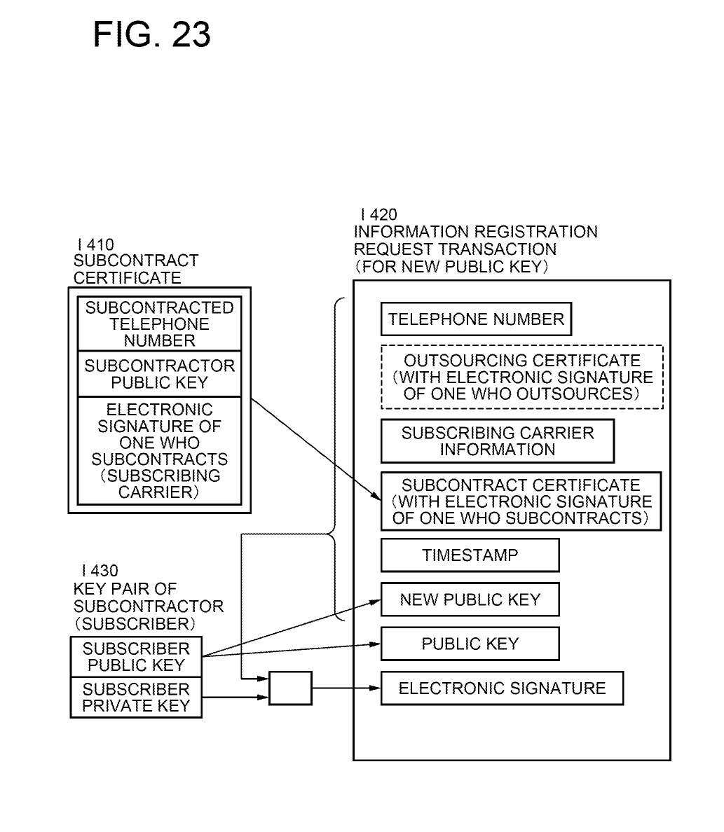

FIG. 23 is an explanatory diagram of Step ST63 for generating an information registration request transaction (for a new public key). An information registration request transaction (for a new public key) I420 includes a telephone number, an outsourcing certificate (with an electronic signature of one who outsources), subscribing carrier information, a subcontract certificate (with an electronic signature of one who subcontracts), a timestamp, a new public key (a subscriber public key), a public key (a subscriber public key), and an electronic signature. A subcontract certificate I410 includes a subcontracted telephone number, a subcontractor public key, and an electronic signature of one who subcontracts. The electronic signature included in the transaction is a signature with a subscriber private key on the telephone number, the outsourcing certificate (with the electronic signature of one who outsources), the subscribing carrier information, the subcontract certificate (with the electronic signature of one who subcontracts), the timestamp, and the new public key (the subscriber public key). The outsourcing certificate may be omitted.

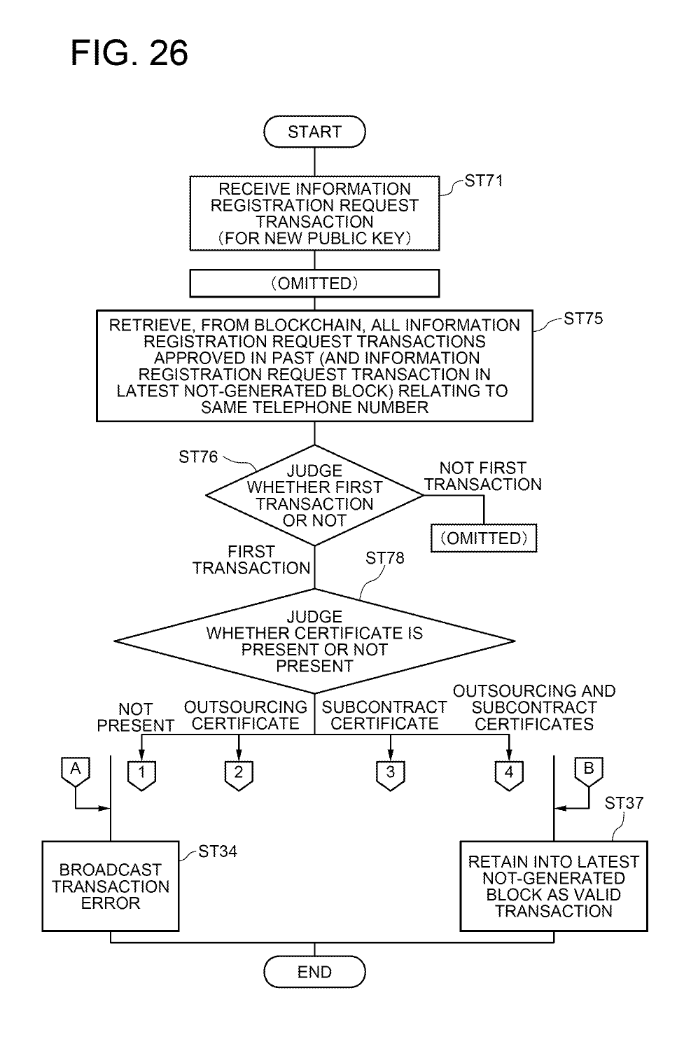

Next, the operation of the node 440, 540, 640 will be described with reference to FIGS. 26 to 30. FIGS. 26 to 30 are flowcharts showing an example of processing by the node 440, 540, 640 participating in the peer-to-peer network. The processing is equivalent to the processing executed by the blockchain management part 2g of the node device 2a shown in FIG. 38.

With reference to FIGS. 26 to 30, upon receiving an information registration request transaction broadcast from the information registrant device 3 (the number management bureau device 400 in FIG. 14, the initial telecommunications carrier device 510 in FIG. 18, the subscriber device 600 in FIG. 22) (ST71), the blockchain management part 2g executes a process that is not shown in FIG. 26 such as judgment of the validity of an electronic signature and then, if the electronic signature is valid, the blockchain management part 2g retrieves, from the blockchain, all information registration request transactions approved in the past (and an information registration request transaction in the latest not-generated block) relating to the same telephone number (or number range or discontinuous numbers) as a telephone number (or number range or discontinuous numbers) included in the currently received information registration request transaction (ST75).

Next, the blockchain management part 2g judges whether or not the currently received information registration request transaction is a first transaction relating to the telephone number (or number range or discontinuous numbers) based on the retrieval result (ST76). If the transaction is not a first transaction, the blockchain management part 2g executes the process that is not shown in FIG. 26. On the other hand, if the transaction is a first transaction, the blockchain management part 2g executes the following process.

The blockchain management part 2g judges whether or not the received information registration request transaction includes a certificate and, if a certificate is included, judges the kind of the certificate (ST78). Then, the blockchain management part 2g executes a process corresponding to the judgment result.

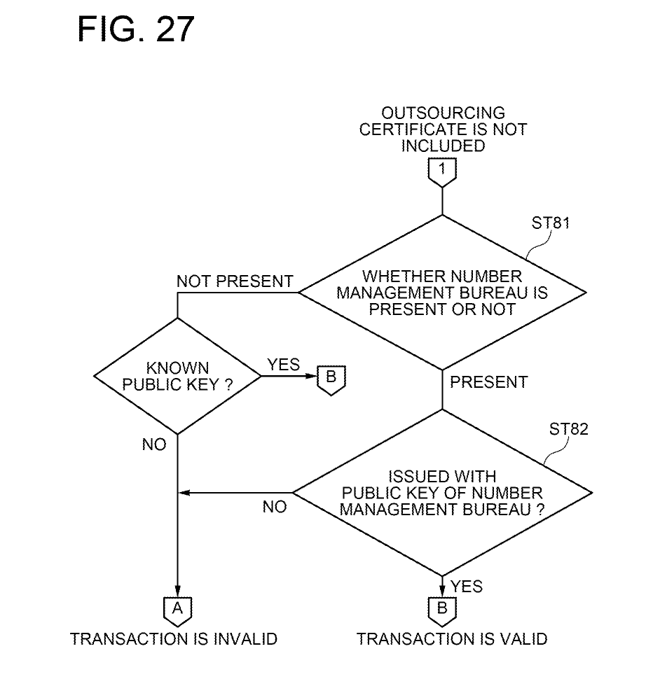

First, in a case where a certificate is not included, the blockchain management part 2g judges the transaction as a valid transaction if there is a number management bureau and the transaction has been issued with its public key or if there is no number management bureau and the transaction is issued with a known public key, whereas the blockchain management part 2g judges the transaction as an invalid transaction in the other cases (FIG. 27).

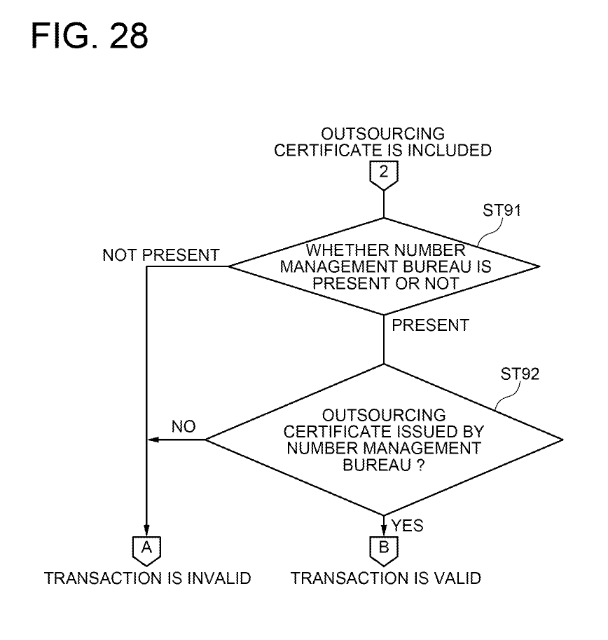

Further, in a case where an outsourcing certificate is included, the blockchain management part 2g judges the transaction as a valid transaction if there is a number management bureau and the outsourcing certificate has been issued thereby, whereas the blockchain management part 2g judges the transaction as an invalid transaction in the other cases (FIG. 28).

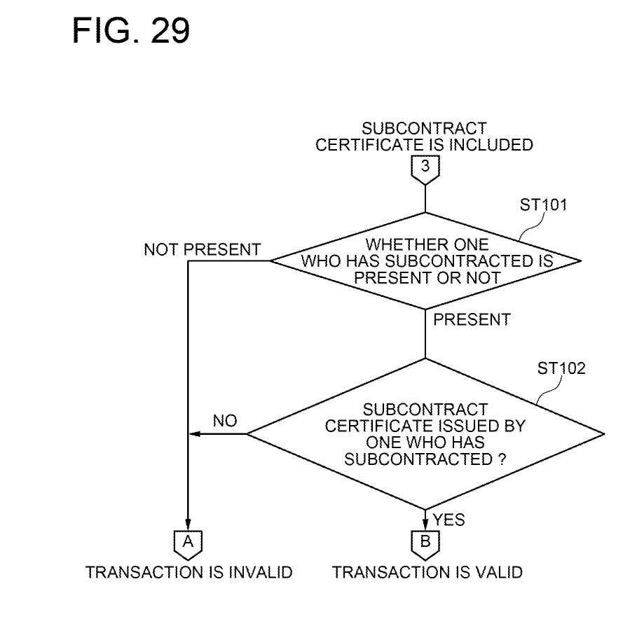

Further, in a case where a subcontract certificate is included, the blockchain management part 2g judges the transaction as a valid transaction if one who has subcontracted is present and the subcontract certificate has been issued thereby, whereas the blockchain management part 2g judges the transaction as an invalid transaction in the other cases (FIG. 29).

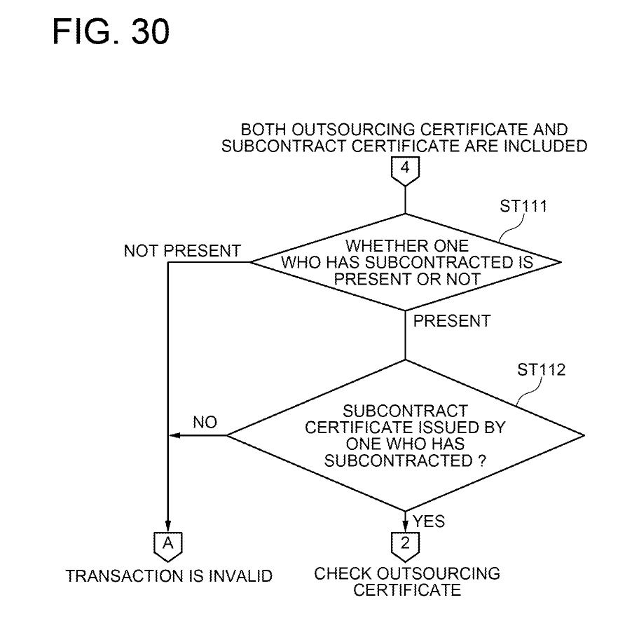

Further, in a case where both an outsourcing certificate and a subcontract certificate are included, if one who has subcontracted is present and the subcontract certificate has been issued thereby, the blockchain management part 2g judges the transaction as a valid transaction by the processing shown in FIG. 29 in the same manner as in the case where a subcontract certificate is included. If one who has subcontracted is not present, or if one who has subcontracted is present but the subcontract certificate has not been issued thereby, the blockchain management part 2g judges the transaction as an invalid transaction (FIG. 30).

### Seventh Example Embodiment

In this example embodiment, a number portability management system that is robust against an attack that, for the purpose of launching a DoS attack against a telecommunications carrier, a malicious third person broadcasts an information registration request transaction with many and unspecified telephone numbers as the same subscribing carrier information will be described.

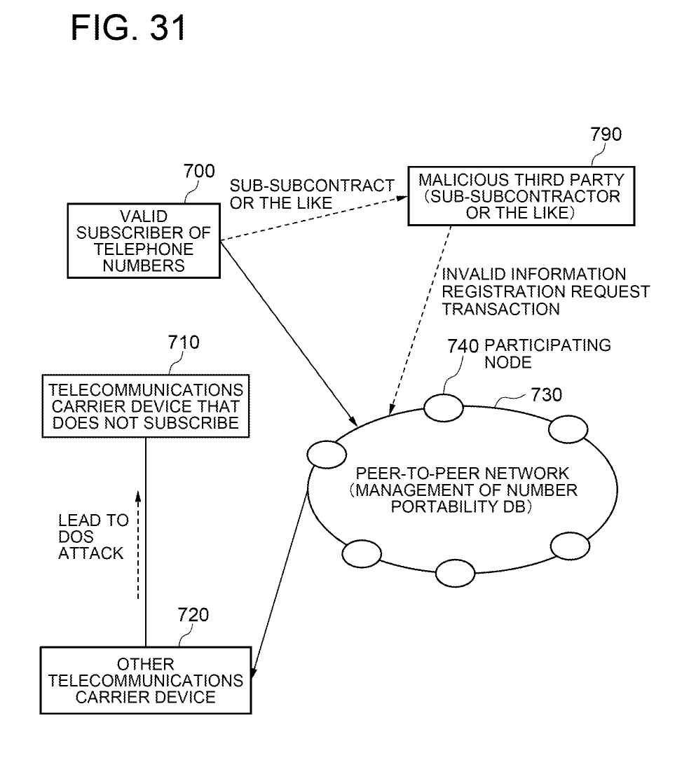

FIG. 31 shows a scene in which a person who has been, for example, sub-subcontracted by a valid subscriber 700 of a plurality of telephone numbers becomes a malicious third person 790 and, in order to associate many and unspecified telephone numbers with carrier information of a telecommunications carrier device 710 which has no subscription, broadcasts an invalid information registration request transaction. When such an invalid information registration request transaction is registered as a valid transaction to a number portability DB of each node 740 participating in a peer-to-peer network 730, the peer-to-peer network 730 returns an invalid response to a query by another telecommunications device 720, and consequently, the other telecommunications carrier device 720 launches a DoS attack against the telecommunications carrier device 710 that has no contract.

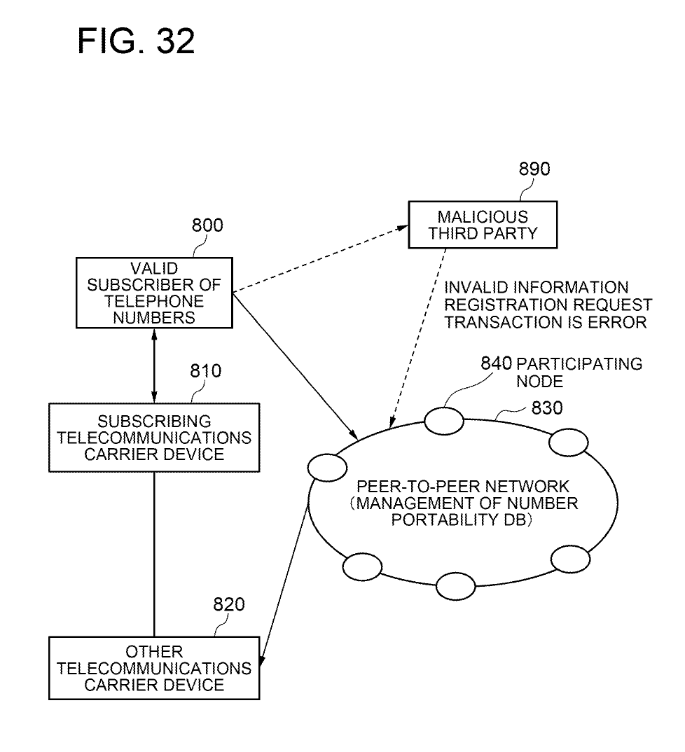

FIG. 32 is a configuration diagram of a number portability information management system according to this example embodiment, which includes a valid subscriber 800 of telephone numbers, a subscribing telecommunications carrier device 810, another telecommunications carrier device 820, a peer-to-peer network 830, and a node 840 participating therein. Reference numeral 890 denotes a malicious third party.

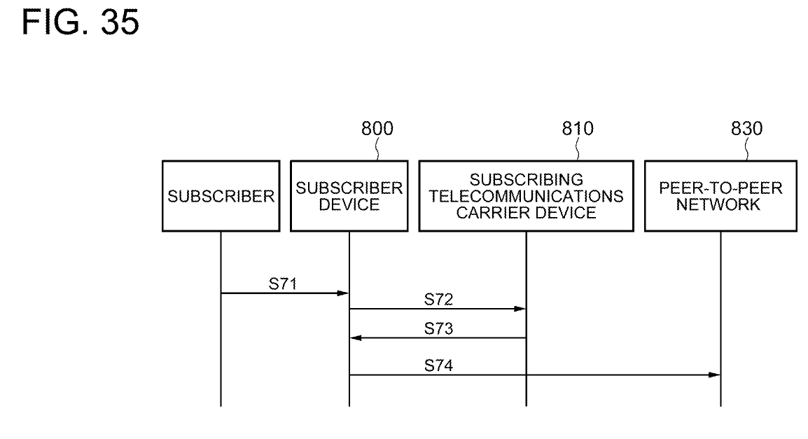

FIG. 35 is a signal sequence diagram showing how an information registration request transaction is broadcast from the subscriber device 800 to the peer-to-peer network 830 managing the number portability DB. FIG. 35 shows how, after the subscriber inputs necessary information into the subscriber device 800 and the device 800 acquires necessary information from the subscribing telecommunications carrier device 810, an information registration request transaction made by providing the above-described information with a timestamp and electronically signing with a private key is broadcast to the peer-to-peer network 830.

In FIG. 35, Signal S71 shows an information input signal sent from the subscriber to the subscriber device 800. Signal S71 includes a private key and public key pair of the subscriber and information (URL or the like) of the subscribing telecommunications carrier device 810. Signal S72 is a signal to request acquisition of subscribing carrier information, a subscription certificate (with an electronic signature of the subscribing carrier) and so on, sent to the subscribing telecommunications carrier device 810 from the subscriber device 800, and Signal S73 is a response signal thereto. Signal S72 includes the URL or the like of the subscribing telecommunications carrier device. Signal S73 includes subscribing carrier information and a subscription certificate (with an electronic signature of the subscribing carrier). Signal S74 is an information registration request transaction signal that is broadcast by the subscriber device 800 to the peer-to-peer network 830.

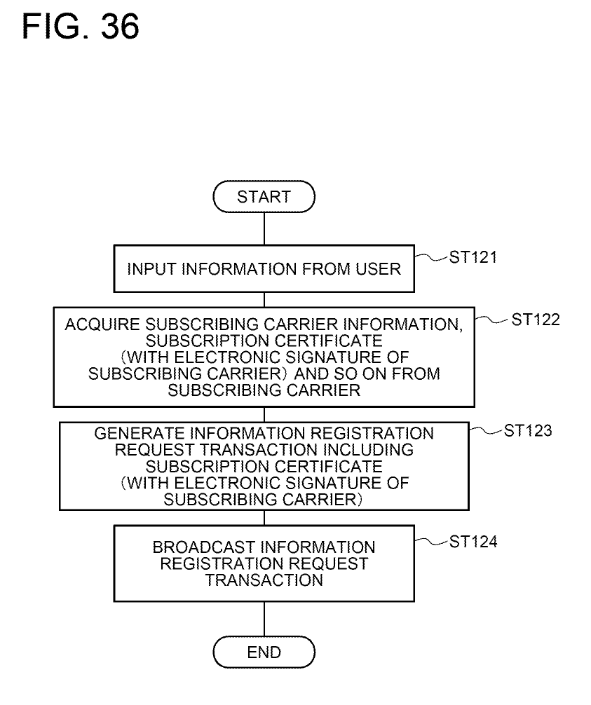

FIG. 36 is a flow diagram showing how the subscriber device 800 transmits an information registration request signal to the peer-to-peer network 830 managing the number portability DB. Step ST121 is a step in which the device 800 inputs the above information input by the user. Step ST122 is a step in which the device 800 queries the subscribing telecommunications carrier device 810 about the above information. Step ST123 is a step in which the device 800 generates an information registration request transaction. Step ST124 is a step in which the device 800 broadcasts the generated information registration request transaction to the peer-to-peer network 830.

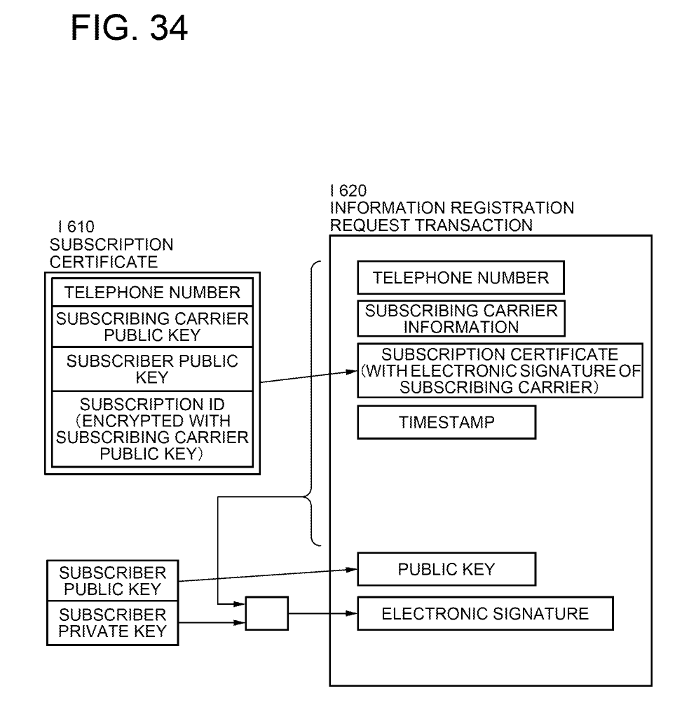

FIG. 34 is an explanatory diagram of Step ST123 for generating an information registration request transaction. An information registration request transaction I620 includes a telephone number, subscribing carrier information, a subscription certificate (with an electronic signature of a subscribing carrier), a timestamp, a public key (a subscriber public key), and an electronic signature. A subscription certificate (with an electronic signature of a subscribing carrier) I610 includes a telephone number, a subscribing carrier public key, a subscriber public key, and a subscription ID (encrypted with the subscribing carrier public key). The electronic signature included in the transaction is a signature with a subscriber private key on the telephone number, the subscribing carrier information, the subscription certificate (with the electronic signature of the subscribing carrier), and the timestamp.

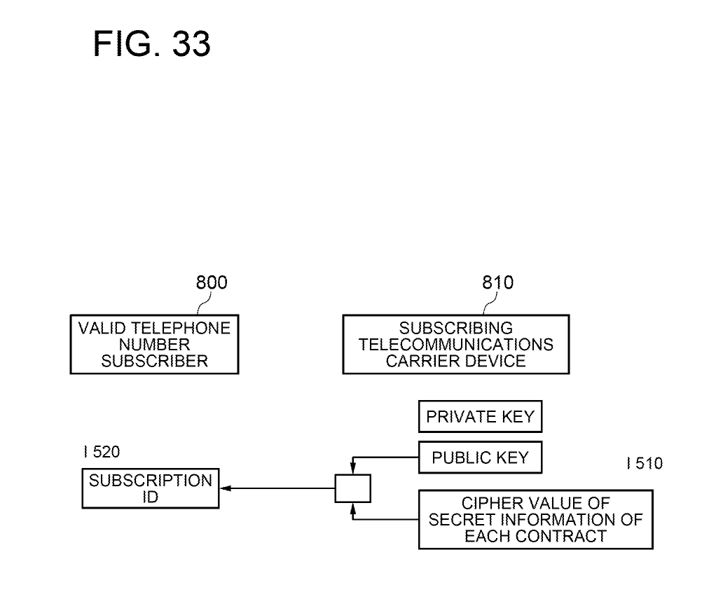

FIG. 33 is an explanatory diagram of a subscription ID (encrypted with a subscribing carrier public key) I520 included in the subscription certificate I610. The subscription ID is made in the subscribing telecommunications carrier device 810 by encrypting a cipher value 151 of secret information of each subscription with a private key of the subscribing telecommunications carrier device 810, and is given to a valid telephone number subscriber.

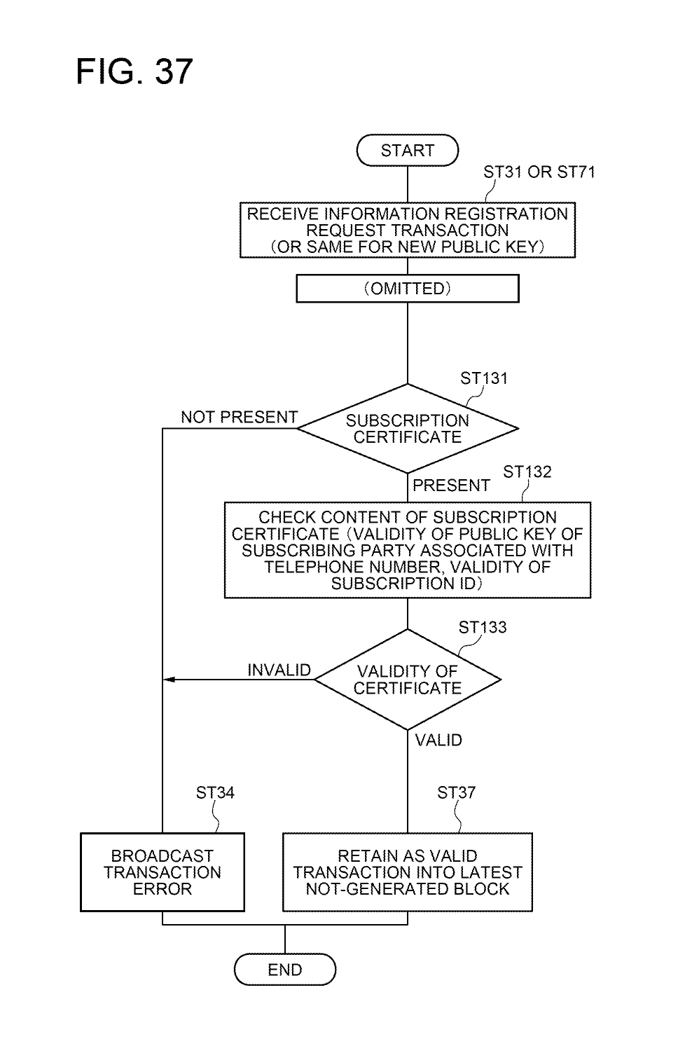

Next, the operation of the node 840 will be described with reference to FIG. 37. FIG. 37 is a flowchart showing an example of processing by the node 840 participating in the peer-to-peer network. The processing is equivalent to the processing executed by the blockchain management part 2g of the node device 2a shown in FIG. 38.

With reference to FIG. 37, upon receiving an information registration request transaction broadcast from the information registrant device 3 (the subscriber device 800 or the malicious third party 890 in FIG. 32) (ST31 or ST71), the blockchain management part 2g executes a process that is not shown in FIG. 37 such as judgment of the validity of an electronic signature and, if the electronic signature is valid, judges whether the currently received information registration request transaction includes a subscription certificate (ST131). In a case where a subscription certificate is not included, the blockchain management part 2g deals with the currently received information registration request transaction as an invalid one and broadcasts a transaction error to the peer-to-peer network (ST34).

On the other hand, in a case where a subscription certificate is included, the blockchain management part 2g checks the content of the subscription certificate (ST132). In checking the content of the subscription certificate, the blockchain management part 2g checks the validity of a public key of a subscribing party associated with the telephone number and the validity of a subscription ID. In the case of judging that the subscription certificate is invalid, the blockchain management part 2g treats the currently received information registration request transaction as an invalid one and broadcasts a transaction error to the peer-to-peer network (ST34). On the other hand, in the case of judging that the subscription certificate is valid, the blockchain management part 2g treats the currently received information registration request transaction as a valid one and retains it into the latest not-generated block (ST37).

Thus, in this example embodiment, in an information registration request transaction, secret information that is known only by the user and the subscribing carrier is included as a subscription ID encrypted with a public key of the subscribing carrier. Because a malicious third party does not know the subscription ID, the malicious third party cannot issue an information registration request transaction including the subscription ID. Therefore, it is possible to prevent an influence by an invalid information registration request transaction described above.

### Eighth Example Embodiment

In this example embodiment, the summary of the present invention will be described.

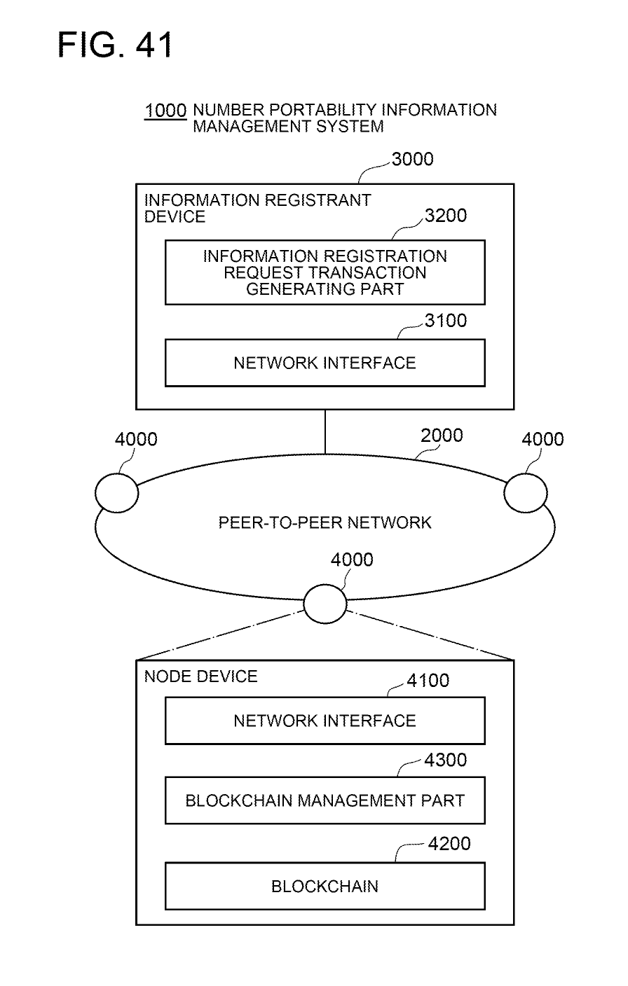

With reference to FIG. 41, a number portability information management system 1000 according to this example embodiment includes a peer-to-peer network 2000 including a plurality of node devices 4000 capable of peer-to-peer communication with each other, and an information registrant device 3000.

The information registrant device 3000 includes a network interface 3100 and an information registration request transaction generating part 3200. The information registration request transaction generating part 3200 has a function to generate an information registration request transaction and broadcast the transaction to the peer-to-peer network 2000 via the network interface. To be more specific, the information registration request transaction generating part 3200 is configured to generate an information registration request transaction based on information including a telephone number of a user terminal and subscribing carrier information, an electronic signature signed on the information by using a private key of the user terminal, and a public key paired with the private key. The information registration request transaction generating part 3200 can be configured in a similar manner as the information registration request transaction generating part described in the first to sixth example embodiments, but is not limited thereto.

Each of the node devices 4000 includes a network interface 4100, a blockchain 4200, and a blockchain management part 4300. The blockchain 4200 is a data structure in which blocks each grouping transactions over a certain period are connected in a chain. For example, the blockchain 4200 may be a blockchain of Ethereum, but is not limited thereto. The blockchain 4200 is also referred to as a number portability DB. The blockchain management part 4300 has a function to accumulate information registration request transactions received through the network interface 4100 into the blockchain 4200 based on a consensus building algorithm executed in cooperation with the other node device 4000. The blockchain management part 4300 may be configured in a similar manner to the blockchain management parts described in the first to sixth example embodiments, but is not limited thereto.

The number portability information management system 1000 thus configured according to this example embodiment operates in the following manner. That is to say, the information registrant device 3000 causes the information registration request transaction generating part 3200 to generate an information registration request transaction based on information including a telephone number of a user terminal and subscribing carrier information, an electronic signature which is a signature with a private key of the user terminal on the information, and a public key paired with the private key. Next, the information registrant device 3000 causes the network interface 3100 to broadcast the information registration request transaction to the peer-to-peer network 2000.

Each of the node devices 4000 causes the network interface 4100 to receive the information registration request transaction having been broadcast. Next, each of the node devices 4000 causes the blockchain management part 4300 to accumulate the received information registration request transactions into the blockchain 4200 based on a consensus building algorithm executed in cooperation with the other node device 4000.

Thus, according to this example embodiment, number portability information is managed by using the blockchain technique, so that a number portability information management system which is excellent in reliability, availability and maintainability can be provided. That is to say, the number portability information management system according to this example embodiment has higher reliability and more excellent availability and so on as compared with a number portability information management system using the existing common DB method. Moreover, the number portability information management system according to this example embodiment is excellent in confidentiality because it is difficult to invade and falsify from outside. Thus, the number portability information management system according to this example embodiment exerts more technical effects than the existing number portability information management system.

Although the present invention has been described above by using some example embodiments, the present invention is not limited to the above example embodiments, and the configurations and details of the present invention can be changed and modified in various manners that can be understood by one skilled in the art within the scope of the present invention.

The present invention is based upon and claims the benefit of priority from Japanese patent application No. 2016-148245, filed on Jul. 28, 2016, the disclosure of which is incorporated herein in its entirety by reference.

The present invention can be utilized in the telecommunications network field of routing by using a telephone number.

The whole or part of the example embodiments disclosed above can be described as, but not limited to, the following supplementary notes.

### (Supplementary Note 1)

A node device configuring a peer-to-peer network, the node device comprising:

a network interface; and

a blockchain management part configured to receive an information registration request transaction via the network interface and accumulate the received information registration request transaction into a blockchain based on a consensus building algorithm executed in cooperation with another node device configuring the peer-to-peer network, the information registration request transaction including information including a telephone number of a user terminal and subscribing carrier information, an electronic signature made on the information with a private key of the user terminal, and a public key paired with the private key.

### (Supplementary Note 2)

The node device according to Supplementary Note 1, wherein the blockchain management part is configured to retrieve another information registration request transaction including a same telephone number as the telephone number included in the received information registration request transaction, from the blockchain, and judge validity of the received information registration request transaction based on a result of comparison of the public key included in the other information registration request transaction having been retrieved with the public key included in the received information registration request transaction.

### (Supplementary Note 3)

The node device according to Supplementary Note 2, wherein the blockchain management part is configured to judge the received information registration request transaction to be valid when the public key included in the received information registration request transaction matches the public keys included in all the other information registration request transactions having been retrieved.

### (Supplementary Note 4)

The node device according to Supplementary Note 2, wherein the blockchain management part is configured to judge the received information registration request transaction to be valid when the public key included in the received information registration request transaction matches a latest public key included in the other information registration request transaction having been retrieved.

### (Supplementary Note 5)

The node device according to Supplementary Note 1, wherein the blockchain management part is configured to judge validity of the received information registration request transaction based on an outsourcing certificate or a subcontract certificate included in the received information registration request transaction.

### (Supplementary Note 6)

The node device according to any of Supplementary Notes 1 to 5, the node device further comprising a query response part configured to, upon receiving an information query request via the network interface, acquire subscribing carrier information corresponding to a telephone number included in the information query request from information accumulated in the blockchain and generate a response to be transmitted via the network interface.

### (Supplementary Note 7)

A number portability information management method executed by a node device including a network interface and a blockchain management part and configuring a peer-to-peer network, the number portability information management method comprising:

by the blockchain management part, receiving an information registration request transaction via the network interface, the information registration request transaction including information including a telephone number of a user terminal and subscribing carrier information, an electronic signature made on the information with a private key of the user terminal, and a public key paired with the private key; and

by the blockchain management part, accumulating the received information registration request transaction into a blockchain based on a consensus building algorithm executed in cooperation with another node device configuring the peer-to-peer network.

### (Supplementary Note 8)

A computer program comprising instructions for causing a computer configuring a peer-to-peer network to function as:

a network interface; and

a blockchain management part configured to receive an information registration request transaction via the network interface and accumulate the received information registration request transaction into a blockchain based on a consensus building algorithm executed in cooperation with another node device configuring the peer-to-peer network, the information registration request transaction including information including a telephone number of a user terminal and subscribing carrier information, an electronic signature made on the information with a private key of the user terminal, and a public key paired with the private key.

### (Supplementary Note 9)

An information registrant device broadcasting an information registration request transaction to a peer-to-peer network configured by a plurality of node devices capable of peer-to-peer network with each other, the information registrant device comprising:

a network interface; and

an information registration request transaction generating part configured to generate the information registration request transaction and broadcast the information registration request transaction to the peer-to-peer network via the network interface,

wherein the information registration request transaction generating part is configured to generate the information registration request transaction based on information including a telephone number of a user terminal and subscribing carrier information, an electronic signature made on the information with a private key of the user terminal, and a public key paired with the private key.

### (Supplementary Note 10)

The information registrant device according to Supplementary Note 9, wherein the information registration request transaction generating part is configured to generate the information registration request transaction based on an electronic signature made with the private key of the user terminal on information including the telephone number of the user terminal and a new public key used instead of the public key of the user terminal and based on the public key paired with the private key.

### (Supplementary Note 11)

The information registrant device according to Supplementary Note 9, wherein the information registration request transaction generating part is configured to generate the information registration request transaction based on an electronic signature made with the private key of the user terminal on information including the telephone number of the user terminal and new subscribing carrier information used instead of the subscribing carrier information and based on the public key paired with the private key.

### (Supplementary Note 12)

The information registrant device according to Supplementary Note 9, wherein the information registration request transaction generating part is configured to generate the information registration request transaction based on an electronic signature made with a predetermined private key on information including a telephone number and a new public key and also including an outsourcing certificate or a subcontract certificate and based on a public key paired with the predetermined private key.

### (Supplementary Note 13)

The information registrant device according to any of Supplementary Notes 9 to 12, wherein the information registration request transaction generating part is configured to include a subscription ID made by encrypting secrete information known to only a user of the user terminal and a subscribing carrier with a public key of the subscribing carrier, into the information registration request transaction.

### (Supplementary Note 14)

A number portability information management system comprising a peer-to-peer network configured by a plurality of node devices capable of peer-to-peer communication with each other and an information registrant device, wherein:

the information registrant device includes a first network interface and an information registration request transaction generating part configured to generate an information registration request transaction and broadcast the information registration request transaction to the peer-to-peer network via the first network interface;

the information registration request transaction generating part is configured to generate the information registration request transaction based on information including a telephone number of a user terminal and subscribing carrier information, an electronic signature made on the information with a private key of the user terminal, and a public key paired with the private key; and

each of the node devices includes a second network interface and a blockchain management part configured to accumulate the received information registration request transaction into a blockchain via the second network interface based on a consensus building algorithm executed in cooperation with another node device.

### (Supplementary Note 15)

The number portability information management system according to Supplementary Note 14, wherein the blockchain management part is configured to retrieve another information registration request transaction including a same telephone number as the telephone number included in the received information registration request transaction, from the blockchain, and judge validity of the received information registration request transaction based on a result of comparison of the public key included in the other information registration request transaction having been retrieved with the public key included in the received information registration request transaction.

### (Supplementary Note 16)

The number portability information management system according to Supplementary Note 15, wherein the blockchain management part is configured to judge the received information registration request transaction to be valid when the public key included in the received information registration request transaction matches the public keys included in all the other information registration request transactions having been retrieved.

### (Supplementary Note 17)

The number portability information management system according to Supplementary Note 15, wherein the blockchain management part is configured to judge the received information registration request transaction to be valid when the public key included in the received information registration request transaction matches a latest public key included in the other information registration request transaction having been retrieved.

### (Supplementary Note 18)

The number portability information management system according to Supplementary Note 14, wherein the information registration request transaction generating part is configured to generate the information registration request transaction based on an electronic signature made with the private key of the user terminal on information including the telephone number of the user terminal and a new public key used instead of the public key of the user terminal and based on the public key paired with the private key.

### (Supplementary Note 19)

The number portability information management system according to Supplementary Note 14, wherein the information registration request transaction generating part is configured to generate the information registration request transaction based on an electronic signature made with the private key of the user terminal on information including the telephone number of the user terminal and new subscribing carrier information used instead of the subscribing carrier information and based on the public key paired with the private key.

### (Supplementary Note 20)

The number portability information management system according to Supplementary Note 14, wherein the information registration request transaction generating part is configured to generate the information registration request transaction based on an electronic signature made with a predetermined private key on information including a telephone number and a new public key and also including an outsourcing certificate or a subcontract certificate and based on a public key paired with the predetermined private key.

### (Supplementary Note 21)

The number portability information management system according to Supplementary Note 20, wherein the blockchain management part is configured to judge validity of the received information registration request transaction based on an outsourcing certificate or a subcontract certificate included in the received information registration request transaction.

### (Supplementary Note 22)

The number portability information management system according to any of Supplementary Notes 14 to 21, wherein the information registration request transaction generating part is configured to include a subscription ID made by encrypting secrete information known to only a user of the user terminal and a subscribing carrier with a public key of the subscribing carrier, into the information registration request transaction.

### (Supplementary Note 23)

The number portability information management system according to any of Supplementary Notes 14 to 22, wherein each of the node devices further includes a query response part configured to, upon receiving an information query request via the second network interface, acquire subscribing carrier information corresponding to a telephone number included in the information query request from information accumulated in the blockchain and generate a response to be transmitted via the second network interface.

### DESCRIPTION OF NUMERALS

1 number portability information management system
2 peer-to-peer network
2a node device
2b network interface
2c arithmetic processing part
2d storage part
2e program
2f blockchain
2g blockchain management part
2h query response part
3 information registrant device
3a network interface
3b arithmetic processing part
3c storage part
3d program
3e information registration request transaction generating part
4 information user device
4a network interface
4b arithmetic processing part
4c storage part
4d program
4e information use request transaction generating part
10 information registrant device
20 information user device
30 peer-to-peer network
40 participating node
100 telephone number subscriber device
110 subscribing telecommunications carrier device
120 other telecommunications carrier device
130 peer-to-peer network
140 participating node
I10 telephone number subscriber device retention information
I20 information registration request transaction
I110 new key pair
I120 information registration request transaction (for new public key)
400 number management bureau device
410 initial telecommunications carrier device
420 other telecommunications carrier device
430 peer-to-peer network
440 participating node
I210 new key pair
I220 information registration request transaction (for new public key)
500 number management bureau device
510 initial telecommunications carrier device
520 other telecommunications carrier device
530 peer-to-peer network
540 participating node
I310 outsourcing certificate
I320 information registration request transaction (for new public key)
600 telephone number subscriber device
610 subscribing telecommunications carrier device
620 other telecommunications carrier device
630 peer-to-peer network
640 participating node
I410 subcontract certificate
I420 information registration request transaction (for new public key)
1430 key pair of subcontractor (contractor)
700 valid telephone number subscriber
710 telecommunications carrier device with no contract
720 other telecommunications carrier device
730 peer-to-peer network
740 participating node
790 malicious third party (sub-subcontractor or the like)
800 valid telephone number subscriber
810 telecommunications carrier device with no contract
820 other telecommunications carrier device
830 peer-to-peer network
840 participating node
890 malicious third party
I520 subscription ID
I510 cipher value of secret information of each contract
I610 contract certificate
I620 information registration request transaction
1000 number portability information management system
2000 peer-to-peer network
3000 information registrant device
3100 network interface
3200 information registration request transaction generating part
4000 node device
4100 network interface
4200 blockchain
4300 blockchain management part

1. A node device configuring a peer-to-peer network, the node device comprising:
a network interface; and
a memory including a program instruction; and
a processor connected to the network interface and the memory,
wherein the processor is programmed to execute the program instruction in order to receive an information registration request transaction via the network interface and accumulate the received information registration request transaction into a blockchain based on a consensus building algorithm executed in cooperation with another node device configuring the peer-to-peer network, the information registration request transaction including information including a telephone number of a user terminal and subscribing carrier information, an electronic signature made on the information with a private key of the user terminal, and a public key paired with the private key.

2. The node device according to claim 1, wherein the processor is further programmed to retrieve another information registration request transaction including a same telephone number as the telephone number included in the received information registration request transaction, from the blockchain, and judge validity of the received information registration request transaction based on a result of comparison of the public key included in the other information registration request transaction having been retrieved with the public key included in the received information registration request transaction.

3. The node device according to claim 2, wherein the processor is further programmed to judge the received information registration request transaction to be valid when the public key included in the received information registration request transaction matches the public keys included in all the other information registration request transactions having been retrieved.

4. The node device according to claim 2, wherein the processor is further programmed to judge the received information registration request transaction to be valid when the public key included in the received information registration request transaction matches a latest public key included in the other information registration request transaction having been retrieved.

5. The node device according to claim 1, wherein the processor is further programmed to judge validity of the received information registration request transaction based on an outsourcing certificate or a subcontract certificate included in the received information registration request transaction.

6. The node device according to claim 1 wherein the processor is further programmed to, upon receiving an information query request via the network interface, acquire subscribing carrier information corresponding to a telephone number included in the information query request from information accumulated in the blockchain and generate a response to be transmitted via the network interface.

7. A number portability information management method executed by a node device including a network interface and a processor and configuring a peer-to-peer network, the number portability information management method comprising:
receiving an information registration request transaction via the network interface, the information registration request transaction including information including a telephone number of a user terminal and subscribing carrier information, an electronic signature made on the information with a private key of the user terminal, and a public key paired with the private key; and
accumulating the received information registration request transaction into a blockchain based on a consensus building algorithm executed in cooperation with another node device configuring the peer-to-peer network.

8. (canceled)

9. An information registrant device broadcasting an information registration request transaction to a peer-to-peer network configured by a plurality of node devices capable of peer-to-peer network with each other, the information registrant device comprising:
a network interface;
a memory including a program instruction; and
a processor connected to the network interface and the memory,
wherein the processor is programmed to execute the program instruction in order to generate an information registration request transaction based on information including a telephone number of a user terminal and subscribing carrier information, an electronic signature made on the information with a private key of the user terminal, and a public key paired with the private key and broadcast the information registration request transaction to the peer-to-peer network via the network interface.

10. The information registrant device according to claim 9, wherein the the processor is further programmed to generate the information registration request transaction based on an electronic signature made with the private key of the user terminal on information including the telephone number of the user terminal and a new public key used instead of the public key of the user terminal and based on the public key paired with the private key.

11. The information registrant device according to claim 9, wherein the the processor is further programmed to generate the information registration request transaction based on an electronic signature made with the private key of the user terminal on information including the telephone number of the user terminal and new subscribing carrier information used instead of the subscribing carrier information and based on the public key paired with the private key.

12. The information registrant device according to claim 9, wherein the processor is further programmed generate the information registration request transaction based on an electronic signature made with a predetermined private key on information including a telephone number and a new public key and also including an outsourcing certificate or a subcontract certificate and based on a public key paired with the predetermined private key.

13-23. (canceled)
